(19) United States
(12) Patent Application Publication
(10) Pub. No.: US 2009/0259559 A1
(43) Pub. Date: Oct. 15, 2009

(54) SYSTEM AND METHOD FOR ENHANCED CUSTOMER KIOSK ORDERING

(75) Inventors: Roger D. Carroll, Downers Grove, IL (US); Melody A. Roberts, Chicago, IL (US); Iuri Monteiro de Barros, Sao Paulo - SP (BR); Kalil de Freitas Garcia, Sao Caetano - SP (BR); Gary D. Gilmer, JR., Mount Prospect, IL (US); Erik R. Klimczak, Chicago Heights, IL (US); Denis G. Weil, Chicago, IL (US); Phil N. Le-Brun, Naperville, IL (US); Marlon Smith, Montgomery, IL (US); Masamichi Udagawa, New York, NY (US); Sigrid G. Moeslinger, New York, NY (US); Art Plagens, LaGrange, IL (US); Paul Lloyd Welch, St. Charles, IL (US)

Correspondence Address: NEAL, GERBER, & EISENBERG, SUITE 1700, 2 NORTH LASALLE STREET, CHICAGO, IL, 60602, US

(73) Assignee: Restaurant Technology, Inc., St. Charles, IL (US)

(21) Appl. No.: 12/420,798

(22) Filed: Apr. 8, 2009

Related U.S. Application Data
(60) Provisional application No. 61/043,389, filed on Apr. 8, 2008.

(51) Int. Cl. G06Q 20/00; G07G 1/12; G07G 5/00

(52) U.S. Cl. 705/17; 705/25; 705/24

(57) ABSTRACT

The present disclosure is directed to a system and method for presenting restaurant items for multi-item restaurant item selection through a customer ordering kiosk, comprising the steps of receiving a signal representing that a multi-item restaurant item selection has been made, displaying a first indicator representing that a first restaurant item of a predetermined plurality of restaurant items has been selected and displaying a second indicator representing that a second restaurant item of the predetermined plurality of restaurant items still needs to be selected. The multi-item restaurant item selection represents selection of the predetermined plurality of restaurant items comprising the first restaurant item and the second restaurant item.

### RELATED APPLICATION

This application claims priority to U.S. Provisional Patent Application No. 61/043389, filed Apr. 8, 2008, which is incorporated herein by reference in its entirety.

### TECHNICAL FIELD

This invention relates generally to a customer kiosk ordering system and method. More particularly, the present invention relates to a kiosk ordering system and method for allowing a customer to directly order food and other related products in a manner providing enhanced efficiencies and user interactions with the customer kiosk ordering system and method.

### BACKGROUND OF THE INVENTION

This invention relates generally to customer kiosk ordering systems and methods. Prior customer kiosk ordering systems and methods have been attempted and implemented. One such system is disclosed within U.S. Pat. No. 5,235,509, to Mueller et al., issued Aug. 10, 1993. Specifically, Mueller et al. is directed to a method and apparatus for facilitating self-ordering of items in a fast food environment. The apparatus includes a customer terminal having a touch screen display. The touch screen displays information that assists the customer in becoming acquainted with the self-ordering process. Subsequent screens display information relating to the selection of food items. Indicia on the screens represent food items for selection. Such food items are arranged according to food categories. Touching of indicia representing a particular menu food item acts to cause the item to be ordered. U.S. Pat. No. 5,235,509 is incorporated herein by reference for at least the purpose of giving context to the present invention.

Related U.S. Pat. No. 5,128,862, to Mueller et al., issued Jul. 7, 1992, also discloses (a) sets of one or more customer self-order stations equipped with touch screen input terminals, (b) a cashier station associated with one or more customer stations, (c) a food preparation station, and (d) a manager station, as well as “runner” stations and a central data consolidation station. A customer places his own order at one of the customer stations. Those customers who are unable or unwilling to utilize the self-ordering capabilities of the system can be assisted by employees of the restaurant without disrupting the functioning of the overall system. An employee at the cashier station receives money from the customer in payment of the bill for the order, and operates the cash drawer. Employees of the restaurant prepare orders at the food preparation station, while the manager station monitors the various aspects of the system. U.S. Pat. No. 5,128,862 is incorporated herein by reference for at least the purpose of giving context to the present invention.

U.S. Pat. No. 5,806,071, to Balderrama et al., issued Sep. 8, 1998, discloses a process and system to, using both a template presentation created at one location and a database containing items intended for sale at a sales outlet, configure with a computer, electronic information for presentation at an electronic device with which an item (from the outlet), may be ordered. Specifically, Balederrama et al. discloses a process for presenting display information at an interactive electronic device with which an item may be ordered, comprising the steps of: providing an original template presentation created at a first location to include a plurality of template items; providing a database to include a plurality of database items; and configuring the display information for presentation, to include the step of tagging as active for display, an item cell associated with each template item that is also a database item. U.S. Pat. No. 5,806,071 is incorporated herein by reference for at least the purpose of giving context to the present invention.

However, these prior systems fail to recognize many significant aspects needed for a more efficient and customer friendly experience in ordering restaurant menu items through a customer kiosk. Despite the advances in the field, the quick service restaurant (QSR) industry is in need of more efficient systems and methods for customer-based ordering.

### SUMMARY OF THE INVENTION

The present invention provides a system and method for enhanced customer kiosk ordering. The system may be implemented in a variety of ways, including as a computer readable medium, for allowing a customer to directly order food and other related products in a manner providing enhanced efficiencies and user interactions with the customer kiosk ordering system.

One embodiment of the present invention is directed to a system and method for presenting restaurant items for ordering through a customer ordering kiosk, comprising the steps of displaying a first restaurant item category selector within a first ordering interface screen, wherein the first restaurant item category comprises a first background indicia pattern, displaying a second restaurant item category selector within the first ordering interface screen, wherein the second restaurant item category selector comprises a second background indicia pattern that is visually different from the first indicia pattern and displaying a third restaurant item category selector within the first ordering interface screen, wherein the third restaurant item category selector comprises a third background indicia pattern. When a selection signal is received representing that one of the first, second, and third restaurant item category selectors has been selected, the kiosk displays a first restaurant item selector comprising a restaurant item background pattern that matches the one of the first, second and third background indicia patterns of the respective selected first, second, and third restaurant item category selectors and displays a second restaurant item selector comprising the same restaurant item background pattern that matches the one of the first, second and third background indicia patterns of the respective selected first, second, and third restaurant item category selectors.

Another embodiment of the present invention is directed to a system and method for presenting restaurant items for ordering through a customer kiosk, comprising the steps of displaying a first and second restaurant menu category selector within an ordering interface screen, receiving a selection signal representing that one of the first or second restaurant menu category selectors has been selected and displaying the restaurant menu that corresponds to the selection signal. The first restaurant menu category selector is representative of a first restaurant menu and the second restaurant menu category selector is representative of a second restaurant menu. Additionally, the first restaurant menu comprises a first set of restaurant item selectors and the second restaurant menu comprises a second set of restaurant item selectors.

Another embodiment of the present invention is directed to a system and method for presenting restaurant items for ordering through a customer ordering kiosk, comprising the steps of displaying a first restaurant item image within a first area of a first ordering interface screen, displaying a second restaurant item image within a second area of the first ordering interface screen and displaying a first restaurant item selector for selecting the first restaurant item, wherein at least a portion of the first restaurant item selector is positioned within the first area of the first ordering interface screen. The first and second restaurant item images represent first and second restaurant items that can be ordered respectively using the customer ordering kiosk.

Another embodiment of the present invention is directed to a system and method of efficiently facilitating the selection and purchase of a restaurant item using a customer ordering kiosk comprising displaying a set of restaurant items available for purchase on a first ordering interface screen, receiving a triggering signal, displaying an overlay interface screen and preventing the first ordering interface screen from receiving any input from a customer while the overlay interface screen is displayed. The triggering signal can represent that a restaurant item has been selected, customization of a restaurant item has been completed, the customer has finished selecting restaurant items or a predetermined amount of time has passed without any input signals being received by the kiosk. Additionally, the overlay interface screen can facilitate meal creation, restaurant item customization, payment and kiosk system timeout.

Another embodiment of the present invention is directed to a system and method for presenting restaurant items for ordering through a customer kiosk, comprising the steps of displaying a list of restaurant item selectors within an ordering interface screen, receiving a selection signal indicating that one of the restaurant items has been selected, displaying one or more of the selected restaurant items within an order cart interface screen, wherein each of the selected restaurant items includes a selector box representing dietary options for the selected restaurant items. A dietary option is a predetermined set of ingredients associated and in accordance with a known set of preferences or nutritional restrictions.

Another embodiment of the present invention is directed to a system and method for presenting restaurant items for ordering through a customer ordering kiosk, comprising the steps of displaying a list of restaurant items within an ordering interface screen, receiving a selection signal indicating that one or more of the restaurant items has been selected, displaying one or more of the selected restaurant items within an order cart interface screen and receiving a selection signal indicating that a selector box corresponding to the ingredient option has been selected. Each of the selected restaurant items includes at least one selector box representing an ingredient option for the selected restaurant item that the customer can interact with to customize the amount of that ingredient on the selected restaurant item. If the customer elects to remove an ingredient from the restaurant item, the selected ingredient option is highlighted to indicate that it will be omitted from the restaurant item.

Another embodiment of the present invention is directed to a system and method for presenting restaurant items for ordering through a customer ordering kiosk, comprising the steps of displaying an electronic receipt within an ordering interface screen, displaying one or more restaurant items on the electronic receipt corresponding to restaurant items that were selected by the customer for purchase, displaying a restaurant item symbol corresponding to one or more of the restaurant items displayed on the electronic receipt, displaying an edit button for each of the restaurant items and displaying a total cost line item for aggregating the total cost for all of the selected restaurant items. The restaurant item symbol is displayed in close proximity to its respective restaurant item, and customers may modify existing orders by selecting the edit button and causing an edit signal to be generated. Additionally, the electronic receipt may scroll up and down to display restaurant items that cannot be displayed on a single screen.

Another embodiment of the present invention is directed to a system and method for presenting restaurant items for multi-item restaurant item selection through a customer ordering kiosk, comprising the steps of receiving a signal representing that a multi-item restaurant item selection has been made, displaying a first indicator representing that a first restaurant item of a predetermined plurality of restaurant items has been selected and displaying a second indicator representing that a second restaurant item of the predetermined plurality of restaurant items still needs to be selected. The multi-item restaurant item selection represents selection of the predetermined plurality of restaurant items comprising the first restaurant item and the second restaurant item.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a graphical representation of an enhanced customer kiosk ordering system.

FIG. 2 is a front view of one embodiment of a customer kiosk of the present invention.

FIG. 3 is a flowchart showing a first exemplar embodiment of the enhanced customer ordering taking system 410 of FIG. 4.

FIG. 4 is a block diagram represents a computer used to implement the present invention. In one form, the computer may be the local kiosk server or computer of FIG. 1. The computer includes a memory element. The memory element includes a computer readable medium for implementing the customer kiosk ordering system and method.

FIG. 5 is one customer ordering interface screen of the system of the embodiment of FIG. 3.

FIG. 6 is a further customer ordering interface screen of the system of the embodiment of FIG. 3.

FIG. 7 is a further customer ordering interface screen of the system of the embodiment of FIG. 3.

FIG. 8 is a flowchart showing a second exemplar embodiment of the enhanced customer ordering taking system 310, 410 of FIGS. 3 and 4.

FIG. 9 is one customer ordering interface screen of the system of the embodiment of FIG. 8.

FIG. 10 is a flowchart showing a third exemplar embodiment of the enhanced customer ordering taking system 310, 410 of FIGS. 3 and 4.

FIG. 11 is one customer ordering interface screen of the system of the embodiment of FIG. 10.

FIG. 12 is one customer ordering interface screen of the system of the embodiment of FIG. 10.

FIG. 13 is a flowchart showing a fourth exemplar embodiment of the enhanced customer ordering taking system 310, 410 of FIGS. 3 and 4.

FIG. 14 is one customer ordering interface screen of the system of the embodiment of FIG. 13.

FIG. 15 is one customer ordering interface screen of the system of the embodiment of FIG. 13.

FIG. 16 is a flowchart showing a fifth exemplar embodiment of the enhanced customer ordering taking system 310, 410 of FIGS. 3 and 4.

FIG. 17 is a flowchart showing a sixth exemplar embodiment of the enhanced customer ordering taking system 310, 410 of FIGS. 3 and 4.

FIG. 18 is one customer ordering interface screen of the system of the embodiment of FIG. 17.

FIG. 19 is a flowchart showing a seventh exemplar embodiment of the enhanced customer ordering taking system 310, 410 of FIGS. 3 and 4.

FIG. 20 is one customer ordering interface screen of the system of the embodiment of FIG. 19.

FIG. 21 is a flowchart showing an eighth exemplar embodiment of the enhanced customer ordering taking system 310, 410 of FIGS. 3 and 4.

FIG. 22 is one customer ordering interface screen of the system of the embodiment of FIG. 21.

FIG. 23 is one customer ordering interface screen of the system of the embodiment of FIG. 21.

FIG. 24 is one customer ordering interface screen of the system of the embodiment of FIG. 21.

FIG. 25 is one customer ordering interface screen of the system of the embodiment of FIG. 21.

FIG. 26 is one customer ordering interface screen of the system of the embodiment of FIG. 21.

FIG. 27 is one customer ordering interface screen of the system of the embodiment of FIG. 21.

FIG. 28 is one customer ordering interface screen of the system of the embodiment of FIG. 21.

FIG. 29 is one customer ordering interface screen of the system of the embodiment of FIG. 21.

FIG. 30 is one customer ordering interface screen of the system of the embodiment of FIG. 21.

FIG. 31 is one customer ordering interface screen of the system of the embodiment of FIG. 21.

FIG. 32 is one customer ordering interface screen of the system of the embodiment of FIG. 21.

FIG. 33 is a flowchart showing a ninth exemplar embodiment of the enhanced customer ordering taking system 310, 410 of FIGS. 3 and 4.

FIG. 34 is one customer ordering interface screen of the system of the embodiment of FIG. 33.

FIG. 35 is one customer ordering interface screen of the system of the embodiment of FIG. 33.

FIG. 36 is one customer ordering interface screen of the system of the embodiment of FIG. 33.

FIG. 37 is one customer ordering interface screen of the system of the embodiment of FIG. 33.

FIG. 38 is one customer ordering interface screen of the system of the embodiment of FIG. 33.

FIG. 39 is one customer ordering interface screen of the system of the embodiment of FIG. 33.

### DETAILED DESCRIPTION

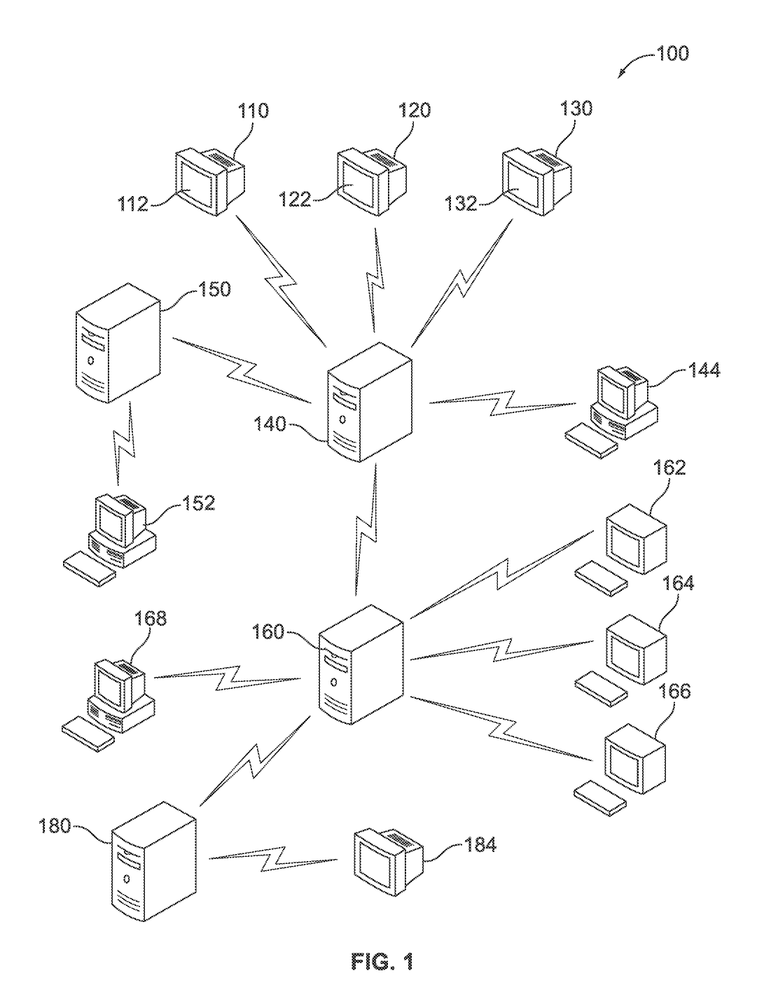

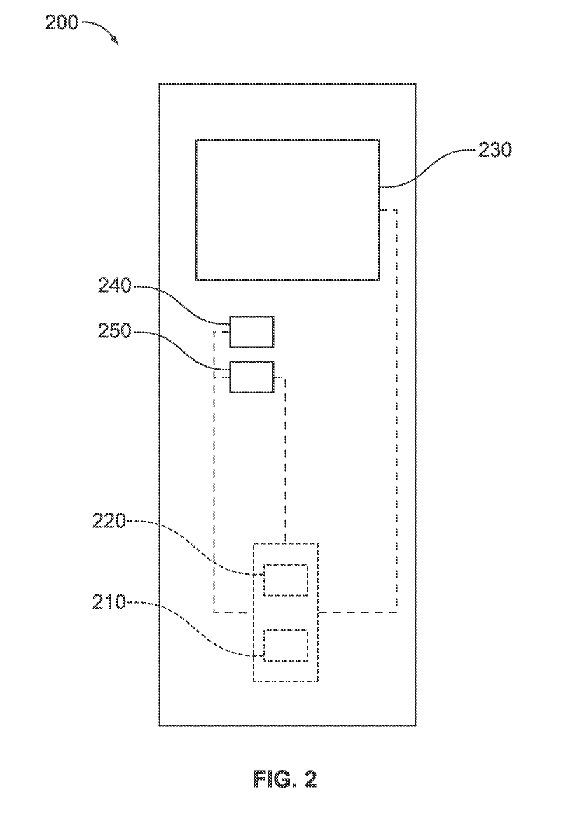

FIG. 1 is a graphical representation of an enhanced customer kiosk ordering system 100. The system 100 includes a plurality of customer kiosks 110, 120, 130, which can take several different forms. Specifically, referring to FIG. 2, a front view of one embodiment of a customer kiosk 200, which can be used as the customer kiosks 110, 120, 130 of FIG. 1. In one form, the customer kiosk 200 can be a free standing or stand-alone apparatus. In another form, the customer kiosk 200 can be mounted to a counter-top instead of being a stand-alone apparatus. In either form, each customer kiosk 110, 120, 130, 200 can include a microprocessor 210 (not shown in FIG. 1), a memory 220 (not shown in FIG. 1), a touch screen display 112, 122, 132, 230, a credit card or payment card reader 240, and a receipt dispenser 250. The customer kiosk 110, 120, 130, 200 can include a computer having one or more of these elements, as well as a CD-ROM drive for uploading software applications and other information. Each customer kiosk 110, 120, 130, 200 can be connected to each other and to other components of the system 100 via a local area Ethernet communications network.

Each customer kiosk can also include an operating system, a credit card reader software application, a receipt dispenser software application, a network communication software application, and a touch screen browser software application, each stored within the memory 220 or other computer hardware device, for operating in connection with the microprocessor 210 or other hardware device. Specifically, the operating system within each customer kiosk is provided for use in executing software applications, such as the credit card reader application, the receipt dispenser application, the network communication application, and/or the touch screen browser application. The credit or payment card reader application receives and/or deciphers credit card information from credit cards that are inserted into the credit card reader 240 for paying for a meal ordered using the customer kiosk 110, 120, 130, 200. In one embodiment, the customer kiosk 110, 120, 130, 200 can be configured to include a cash receiving device, a change dispenser, and an appropriate software application for controlling these devices to receive cash payment and dispense change, as needed, for allowing a customer to pay for an order with cash, instead of with a credit card.

The receipt dispenser application communicates information to the receipt dispenser 250 and controls the operation of the receipt dispenser 250 for printing a receipt. A receipt (not shown) typically includes at least a listing of the restaurant items ordered, the price for each restaurant item ordered, applicable taxes, an identifier, such as a number and/or a bar code, for uniquely identifying the order and the customer which placed the order in order to match the customer with the correct order a pick-up counter, and an indication of whether the order has been paid for at the customer kiosk, such as for example, by using a credit card/debit card and inserting the credit card/debit card into the credit/payment card reader 240. The network communication application communicates or sends information to and receives information from a local customer kiosk server 140.

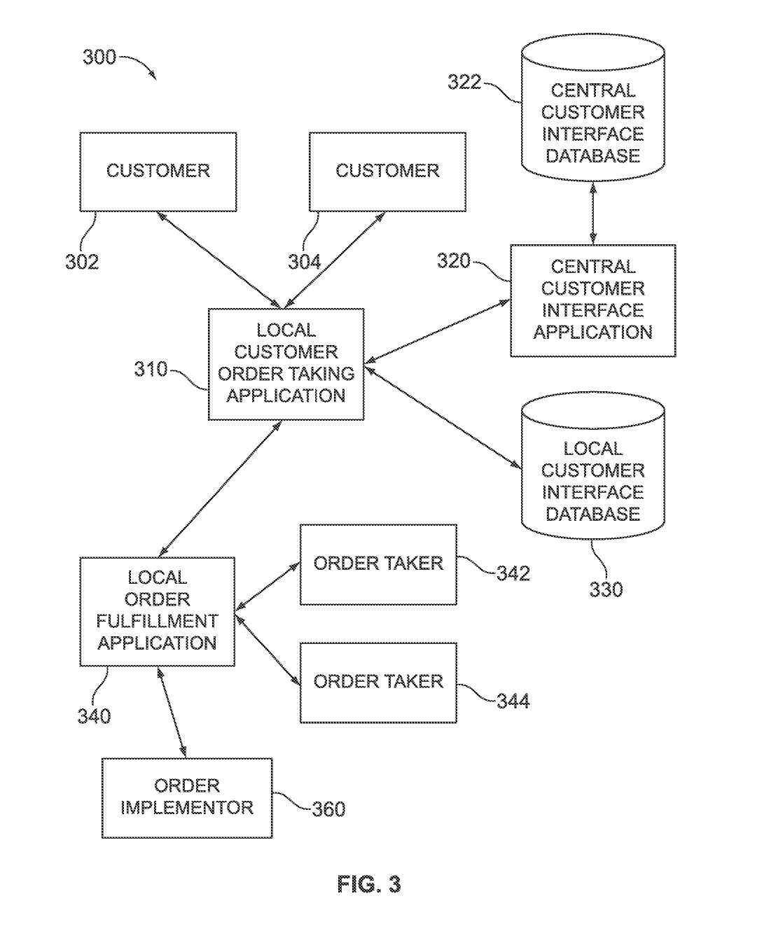

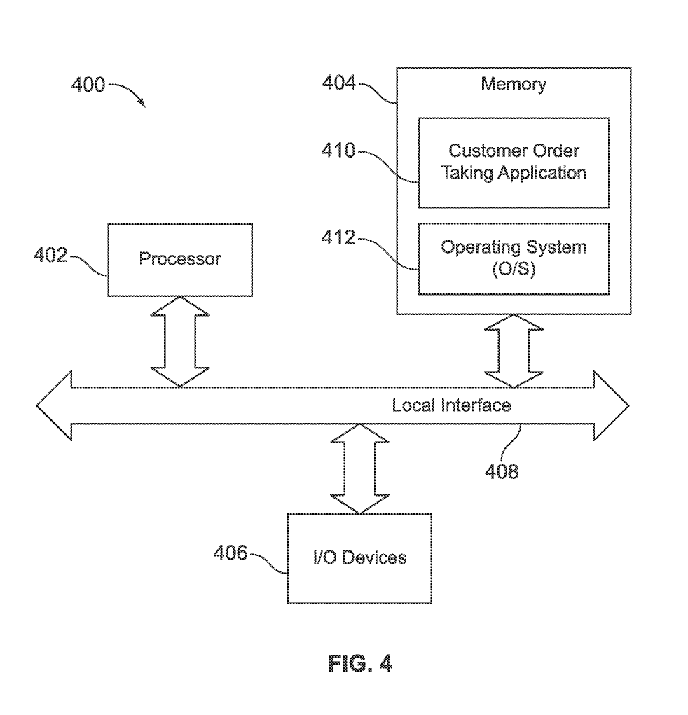

In one embodiment, the touch screen browser application is provided for displaying a plurality of customer ordering interface screens of the present invention and receiving customer selections in response thereto, as will be described in greater detail below. In the embodiment shown in FIG. 1, the local customer kiosk server 140 is in communication with each of the customer kiosks 110, 120, 130, 200, and at least in part generates, launches, communicates, and/or implements the customer ordering interface screens for allowing and causing the touch screen browser application to display the customer ordering interface screens on the touch screen displays 112, 122, 132, 230. FIG. 3 also shows a functional diagram of the enhanced customer kiosk ordering system 100 of FIG. 1 as an enhanced customer kiosk ordering system 300. Specifically, referring to FIGS. 3 and 4, the local customer kiosk server 140 can include a customer order taking software application 310, 410 for launching, communicating, and/or implementing the customer ordering interface screens of the present invention. Alternatively, a copy of the customer order taking software application 310, 410 can reside within the memory 220 of each of the customer kiosks 110, 120, 130, 200, for displaying the customer ordering interface screens on the touch screen displays 112, 122, 132, 230. Specifically, customer kiosks 110, 120, 130, 200 can be connected to each other and to POS terminals 162, 164, 166, kitchen monitors 184 (as well as to a local configuration or management computer 144) by “peer-to-peer” connections. These peer-to-peer connections allow the system 100 to operate without interruption if one of the customer kiosks 110, 120, 130, 200 malfunctions. In this embodiment, there are no restrictions on communication between POS terminals 162, 164, 166 and customer kiosks 110, 120, 130, 200. In other words, specific customer kiosks 110, 120, 130, 200 are not restricted to communicating with specific POS terminals 162, 164, 166, just as specific POS terminals 162, 164, 166 are not designated to communicate with specific customer kiosks 110, 120, 130, 200.

Customers 302, 304 are presented with the customer ordering interface screens as displayed on the touch screen displays 112, 122, 132, 230 by the customer order taking application 310, 410, and the customers 302, 304 can utilize these customer ordering interface screens to select, order, and pay for restaurant menu items. In one embodiment, the customer kiosk 110, 120, 130, 200 presentation on the touch screen display 112, 122, 132, 230 is created and controlled by software, such as the customer order taking application 310, 410 that can be installed on each customer kiosk 110, 120, 130, 200 and information received from the local configuration or management computer 144. When new software is to be installed on the customer kiosks 110, 120, 130, 200, in one embodiment, the software need only be loaded into one customer kiosk 110, 120, 130, 200 through a CD-ROM drive, and all other customer kiosks 110, 120, 130, 200 will automatically update themselves to use the new software through the customer kiosk 110, 120, 130, 200 with the CD-ROM via the Ethernet or other network. The restaurant items or products available and prices for these products can be supplied to all the customer kiosks 110, 120, 130, 200 by the local configuration or management computer 144, which is stored in the memory 220 of each of the customer kiosks 110, 120, 130, 200. Changes to the information in each of the kiosks can be made through the local configuration computer by altering the database on this computer. Thus, the memory of each kiosk can be updated after the database in the local configuration computer is changed. In another embodiment, the local customer kiosk server 140 and the local customer ordering taking application 310, 410 can store and/or retrieve the customer ordering interface screens in and/or from a local customer interface database 330. As provided above, the customer ordering interface screens can also be stored in and/or retrieved the local customer interface database located within the memory 220 of each customer kiosk 110, 120, 130, 200. In the former example, the local customer ordering interface screens can be managed using a local kiosk management computer 144, for later use by and/or downloading into each customer kiosk 110, 120, 130, 200, from the local customer interface database 330 using the local kiosk management computer 144.

The enhanced customer kiosk ordering system 100, 300 can also include central management computers, such as a central management server 150 and a central management client computer 152. A central customer interface application 320 can reside on the a central management server 150 and accessed using a central management client computer 152, which can be located at a company's corporate headquarters, for developing standardized customer ordering interface screens, restaurant menu item images, restaurant menu item icons, and other standardized images and icons for later use within each customer order taking software application 310, 410 at each restaurant or store. The central management server 150 can include and/or the central management server 150 and central management client computer 152 can communicate with a central customer interface database 322 for developing, storing, creating, modifying, adding, and/or deleting standardized customer ordering interface screens, restaurant menu item images, restaurant menu item icons, and other standardized images and icons for later use within each customer order taking software application 310, 410 at each restaurant or store. These standardized customer ordering interface screens, restaurant menu item images, restaurant menu item icons, and other standardized images and icons can be downloaded to, communicated to, and/or received by the local kiosk servers 140, and the local kiosk ordering taking application 310, 410 therein, for storage in and/or retrieval from the local customer interface database 330. As an example, this arrangement can utilized with a franchisor and multiple franchisees, for the franchisor to have each franchisee implement consistent standardized customer ordering interface screens, for presenting a consistent brand identity and for implementing updated customer ordering interface screens, from time to time. Reference can be made to U.S. Pat. No. 5,806,071, to Balderrama et al., issued Sep. 8, 1998 for one central management computer system interfacing with local computer systems, for implementing standardized template ordering interface screens at local restaurants from the central management computer system.

As mentioned, the enhanced customer kiosk ordering system 100, 300 can also include a local kiosk management computer 144. The local kiosk management computer 144 can communicate with and interface with the customer order taking application 310, 410 for adding, removing, modifying, or otherwise managing local restaurant menu items that appear within the customer ordering interface screens when such screens are displayed on the touch screen displays 112, 122, 132, 230, as stored in and/or retrieved from the local customer interface database 330. For example, the local kiosk management computer 144 can be used for adding, removing, and/or modifying local restaurant menu items, increasing and/or decreasing the price of local restaurant menu items, changing the digital images associated with local restaurant menu items, and/or performing other management tasks in relation to the customer ordering interface screens and the content and functions therein. Reference can be made again to U.S. Pat. No. 5,806,071, to Balderrama et al., issued Sep. 8, 1998 for one example of some of this functionality.

The enhanced customer kiosk ordering system 100, 300 can also include a local point of sale (POS) server or computer 160, which is in communication with the local kiosk server 140. The enhanced customer kiosk ordering system 100, 300 can further include POS terminals 162, 164, 166, which are in communication with the local POS server 160, for use by order takers within a restaurant to manually take orders from customers, and to enter such orders into the POS terminals 162, 164, 166 for communication to the POS server 160. The local POS server 160 can include a local order fulfillment software application 340 for operating within the local POS server 160 and within and/or in connection with the POS terminals 162, 164, 166 for receiving orders taken by order takers 342, 344.

A local POS management computer 168 can be used to access management functions within the local order fulfillment software application 340, for example, to add and/or delete restaurant menu items, to modify prices of restaurant menu items, to add and/or delete special restaurant menu items, and/or perform other management functions in connection with functions of the POS terminals, as understood by one of ordinary skill. When an order is generated by a customer kiosk.

The enhanced customer kiosk ordering system 100, 300 can also include a separate local kitchen/order implementation server 180 which is in communication with the local point of sale (POS) server or computer 160. The local order fulfillment software application 340 within the local POS server 160, and/or which can be partially located within the local kitchen/order implementation server 180, can also be used to send communications to order fulfillment monitors 184 located within the kitchen for viewing and use by order implementors 360 to receive instructions on fulfilling orders, also as understood by one of ordinary skill. In this way, the appropriate kitchen employees or implementors 360 are notified to prepare the order. Other order fulfillment monitors (not shown) can be connected to the local point of sale (POS) server or computer 160, and/or to the local kitchen/order implementation server 180, and used for filling orders and/or running orders, as is understood with reference to U.S. Patent Application Publication No. 2007/0022016, to Steres et al., published Jan. 25, 2007 and filed Jul. 22, 2005, which is also hereby incorporated herein by reference in its entirety.

In one embodiment, when an order is being entered by a customer 302, 304 using a customer kiosk 110, 120, 130, 200, each customer kiosk 110, 120, 130, 200 keeps track of the restaurant items which are designated for inclusion within the order, within the memory 220 and/or within a memory within the local kiosk server 140 through the local customer order taking application 310, 410. When the customer has completed the order, the customer is provided an option through one or more of the customer ordering interface screens to pay for the order at the customer kiosk 110, 120, 130 through use of the credit card reader 240, or to pay for the order by walking to one of the POS terminals 162, 164, 166 and offering payment (by credit card, debit card, cash, gift card, gift certificate, SPEEDPASS, or other payment form) to the order takers for entry into one of the POS terminals 162, 164, 166.

If the customer pays using a credit card at the customer kiosk 110, 120, 130, 200, the local customer order taking application 310, 410 and/or the credit card reader application reads and receives the credit card information from the credit card reader 240, and can communicate the credit card information directly to a credit card processing system (in communication with each customer kiosk 110, 120, 130, 200) or through the local kiosk server 140 or the local POS server that is in communication with the credit processing system for approval processing the credit card information. If the order is approved and payment is provided at the customer kiosk 110, 120, 130, 200 through credit card payment, the local customer order taking application 310, 410 and/or the receipt dispenser application prints and dispenses a receipt at the receipt dispenser 250 of the customer kiosk 110, 120, 130, 200, and the local customer order taking application 310, 410 communicates the order to the local order fulfillment application 340 for placing the restaurant menu items within the order within a queue for preparation/creation of the ordered restaurant items and for filling of the order. Once the order is prepared, or the restaurant menu items necessary for the order are prepared, an order taker 342, 344 (or order filler/runner assembler/expediter) fills and presents the filled order to the customer and verifies that the receipt that the customer received from the receipt dispenser 250 matches with the filled order, such as by comparing an order number, bar code, or other matching information provided on the receipt and by the local order fulfillment application 340.

In the case of an order being completed and payment not being provided at the customer kiosk 110, 120, 130, 200 (such as the customer selecting to pay with an order taker 342, 344 by selecting an option provided within one of the customer ordering interface screens to do so, or an attempt to by using a credit card at the customer kiosk 110, 120, 130, 200 is denied), the local customer order taking application 310, 410 communicates the order to the local order fulfillment application 340, and the local order fulfillment application 340 waits for the customer to present payment to one of the order takers 342, 344 at the POS terminals 162, 164, 166. The local customer order taking application 310, 410 and/or the receipt dispenser application prints and dispenses a receipt at the receipt dispenser 250 of the customer kiosk 110, 120, 130, 200, indicating the restaurant items that have been included within the order, the price for each, applicable taxes, and information that can be used to match the receipt/customer with the filled order. The receipt can also include a message to the customer to go to an order taker 342, 344 to pay for the order. The customer then proceeds to order taker to do so. Once the local order fulfillment application 340 determines that the order has been paid for, the local order fulfillment application 340 places the restaurant items within the order within a queue for preparation/creation of the ordered restaurant items and for filling of the order. Once the order is prepared, or the restaurant items necessary for the order are prepared, an order taker 342, 344 (or order filler/runner/assembler/expediter) fills and presents the filled order to the customer and verifies that the receipt that the customer received from the receipt dispenser 250 matches with the filled order, such as by comparing an order number, bar code, or other matching information provided on the receipt and by the local order fulfillment application 340.

Referring to FIG. 4, a block diagram of a computer is shown. The computer may be the local kiosk server and/or the customer kiosks 110, 120, 130, 200 of FIGS. 1 and 2. The computer includes a memory element. The memory element includes a computer readable medium for implementing the kiosk ordering system and method for allowing a customer to directly order food and other related products in a manner providing enhanced efficiencies and user interactions with the customer kiosk ordering system and method.

The customer order taking system 310, 410 can be implemented in software, firmware, hardware, or a combination thereof. In one mode, the customer order taking system 310, 410 is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. Therefore, computer 400 may be representative of any computer in which the customer order taking system 310, 410 resides or partially resides.

Generally, in terms of hardware architecture, as shown in FIG. 4, the computer 400 includes a processor 402, memory 404, and one or more input and/or output (I/O) devices 406 (or peripherals) that are communicatively coupled via a local interface 408. The local interface 408 can be, for example, but not limited to, one or more buses or other wired or wireless connections, as is known in the art. The local interface 408 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 402 is a hardware device for executing software, particularly software stored in memory 404. Processor 402 can be any custom made or commercially available processor, a central processing unit (CPU), an auxiliary processor among several processors associated with the computer 400, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor 402 may also represent a distributed processing architecture such as, but not limited to, SQL, Smalltalk, APL, KLisp, Snobol, Developer 200, MUMPS/Magic.

Memory 404 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 404 may incorporate electronic, magnetic, optical, and/or other types of storage media. Memory 404 can have a distributed architecture where various components are situated remote from one another, but are still accessed by processor 402.

The software in memory 404 may include one or more separate programs. The separate programs comprise ordered listings of executable instructions for implementing logical functions. In the example of FIG. 4, the software in memory 404 includes the customer order taking system 310, 410 in accordance with the present invention, a suitable operating system (O/S) 412. A non-exhaustive list of examples of suitable commercially available operating systems 412 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 412 essentially controls the execution of other computer programs, such as the customer order taking system 310, 410, and provides scheduling, input-output control, file and data management, memory management, and communication control and related services.

The customer order taking system 310, 410 may be a source program, executable program (object code), script, or any other entity comprising a set of instructions to be performed. When a source program, the program needs to be translated via a compiler, assembler, interpreter, or the like, which may or may not be included within the memory 404, so as to operate properly in connection with the O/S 412. Furthermore, the customer order taking system 310, 410 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. In one embodiment, when installed within the memory 220, 404 of each customer kiosk 110, 120, 130, 200, the customer order taking system 310, 410 is written in C/C+/C++ format, and no browser-based software is used. In other embodiments, browser software may be used.

The I/O devices 406 may include input devices, for example but not limited to, credit card readers, input modules for PLCs, a keyboard, mouse, scanner, microphone, touch screens, interfaces for various devices, bar code readers, stylus, laser readers, radio-frequency device readers, etc. Furthermore, the I/O devices 406 may also include output devices, including, but not limited to, receipt dispensers, output modules for PLCs, a printer, bar code printers, displays such as touch screen displays, etc. Finally, the I/O devices 406 may further include devices that communicate both inputs and outputs, for instance but not limited to, a modulator/demodulator (modem; for accessing another device, system, or network), a radio frequency (RF) or other transceiver, a telephonic interface, a bridge, and a router.

If the computer 400 is a PC, workstation, PDA, or the like, the software in the memory 404 may further include a basic input output system (BIOS) (not shown in FIG. 4). The BIOS is a set of essential software routines that initialize and test hardware at startup, start the O/S 412, and support the transfer of data among the hardware devices. The BIOS is stored in ROM so that the BIOS can be executed when computer 400 is activated.

When computer 400 is in operation, processor 402 is configured to execute software stored within memory 404, to communicate data to and from memory 404, and to generally control operations of computer 400 pursuant to the software. The customer order taking system 310, 410, and the O/S 412, in whole or in part, but typically the latter, are read by processor 402, perhaps buffered within the processor 402, and then executed.

When the customer order taking system 310, 410 is implemented in software, as is shown in FIG. 4 by the designation of customer order taking (software) application 410, it should be noted that the customer order taking system 310, 410 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The customer order taking system 310, 410 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the customer order taking system 310, 410 is implemented in hardware, the customer order taking system 310, 410 can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

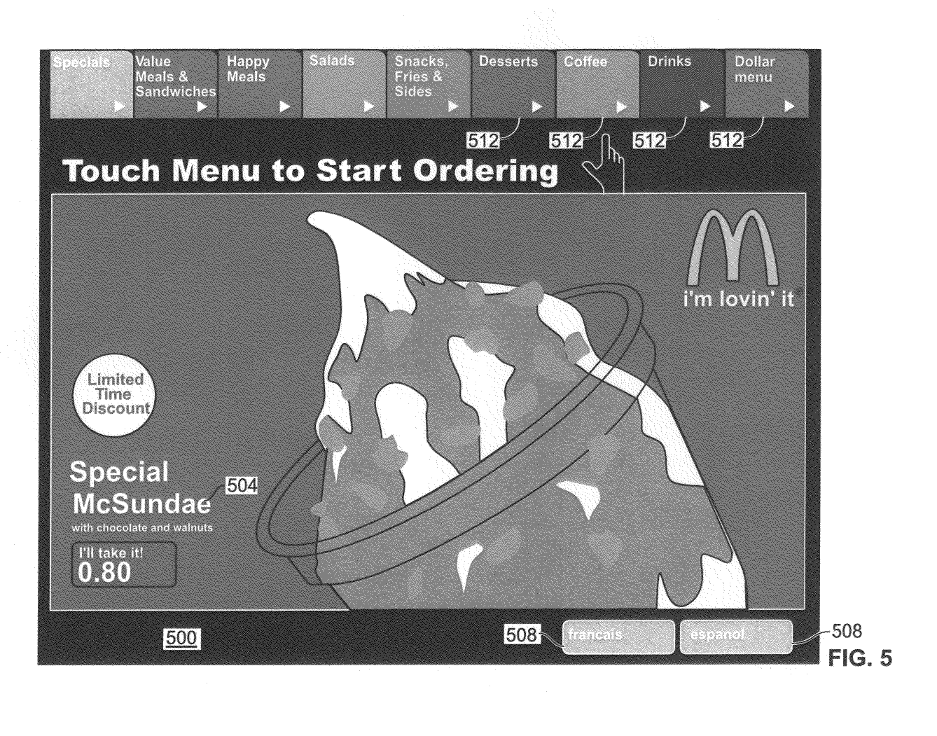

Referring to FIG. 5, in one embodiment, the customer order taking system 310, 410 can be configured to generate and display an opening customer ordering interface screen 500 that allows the customer to begin the order. The opening customer ordering interface screen 500 can be configured to display a restaurant item selector 504 for a special item, such as a sundae, as shown. In one embodiment, the order taking application 310, 410 can be configured to generate and display certain or predetermined special items or other “suggested” restaurant items only during certain time ranges of the day, after certain times of the day, before certain times of the day, on certain days, on certain holidays, during certain months, and/or during certain ranges of days, such as around holidays. In one embodiment, the system and order taking application 310, 410 can be configured to allow a kiosk proprietor to customize these settings. In one embodiment, the kiosk proprietor can include the store manager using the local management computer 144 to configure the order taking application 310, 410 to include particular specials and other related settings, as described herein. In another embodiment, the kiosk proprietor can include an international, national, regional, multi-store franchisee, market, or patch manager or other manager using the central management server 150 and central management client computer 152 or other central management computer(s) to configure one or more order taking application 310, 410 to include particular specials and other related settings, as described herein. The restaurant item selector 504 can include “I'll take it” indicia to indicate that the customer can begin the order by selecting the special restaurant item selector 504 to order the special restaurant item associated therewith. The restaurant item selector 504 can include the price of the restaurant item associated within the restaurant item selector 504. The opening customer ordering interface screen 500 can also be configured to display one or more alternative language selectors 508 for selecting a language, such as Spanish, French, German, Japanese, Chinese, Italian, Russian, etc, for all of the customer ordering interface screens to utilize and display. In one embodiment, a customer can select one or more restaurant items to include within an order within a first set of customer ordering interface screens using a first language. The same or other customer can then select an alternative language selector 508 to change the language for displaying a second set of customer ordering interface screens using a second language. That same or other customer can then select restaurant menu items using the second set of customer ordering interface screens to select additional restaurant items for inclusion within the same order.

The opening customer ordering interface screen 500 and many of the subsequent customer ordering interface screens are configured to display a plurality of restaurant item category selectors 512 identifying different categories of restaurant items from which the customer may select. As will be explained further below, an alternate version of the plurality of restaurant item category selectors, as well as other differences within the customer ordering interface screen, is present during breakfast time, lunch time, dinner time, or other time frame, depending on the country and custom of the region, as well as different types of menus altogether during the same time of day, for example for different types of restaurants that are either connected or housed within the same facility.

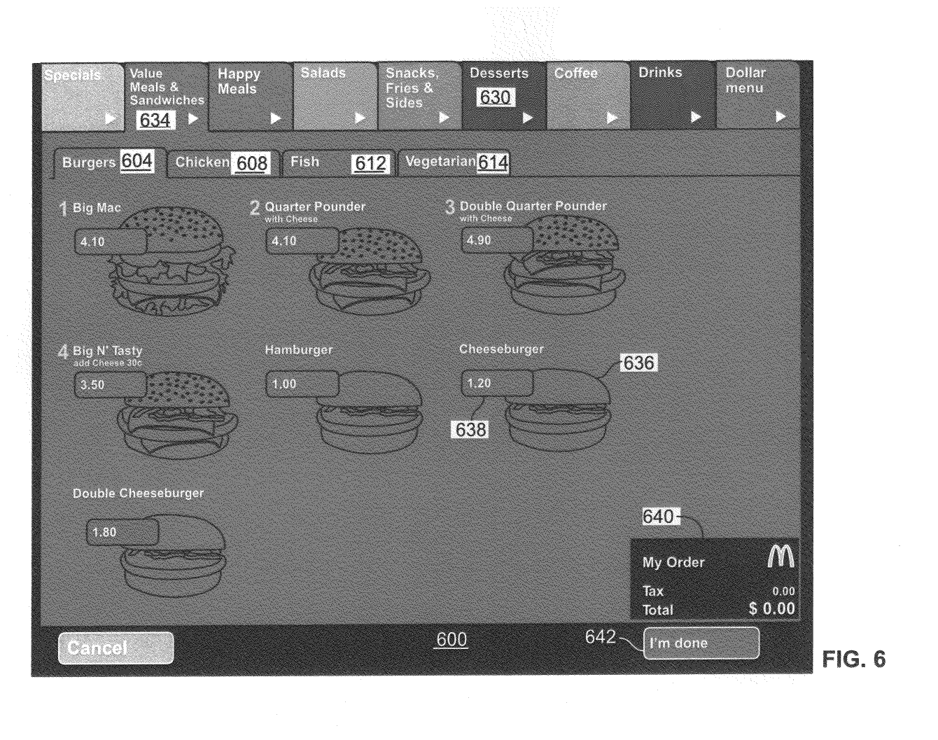

After a restaurant item category is selected, depending on the category selected, the customer order taking system 310, 410 can be configured to generate and display a plurality of restaurant item sub-category selectors for sub-categories of restaurant items from that specific restaurant item category that had been selected. FIG. 6 shows a further customer ordering interface screen 600 which would appear after the customer has selected the Value Meals & Sandwiches restaurant item category selector. In this interface screen 600, the customer order taking system 310, 410 generates and displays the Burgers 604, Chicken 608, Fish 612 and Vegetarian 614 restaurant item sub-category selectors, with various restaurant item selectors 620 within such restaurant item sub-category being shown for allowing the customer to select such restaurant items. This interface screen 600 is also configured to display the plurality of restaurant item category selectors 630 identifying the different categories of restaurant items from which the customer may select to change to another category of restaurant items.

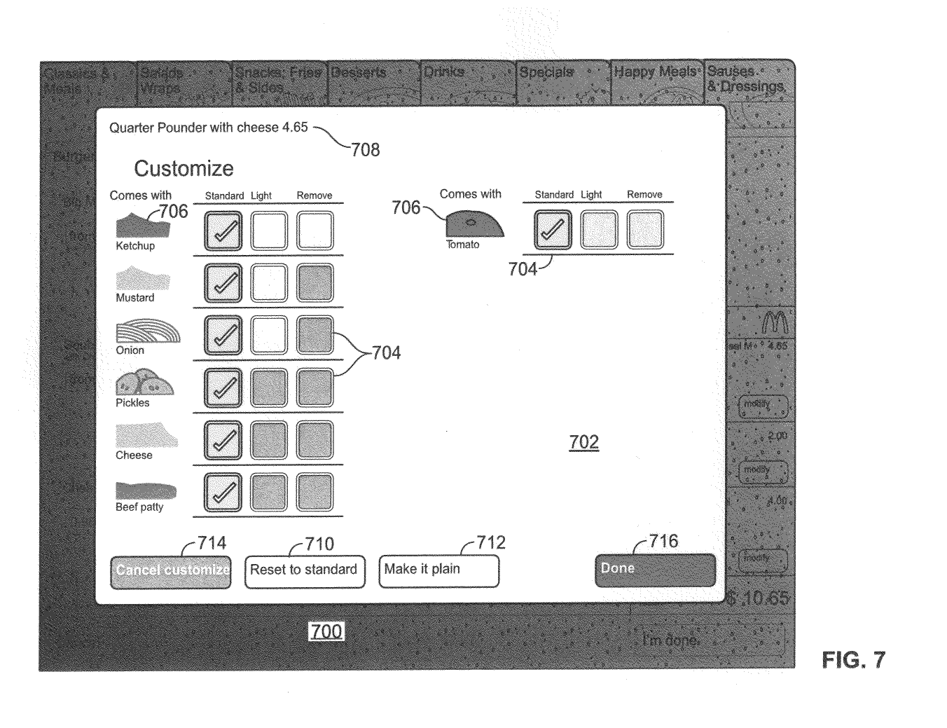

Within one or more customer ordering interface screens, when a restaurant item selector is selected by a customer, one or more option screens may appear in sequence, which allow the customer to specify further details about the item ordered. For example, referring to FIG. 7, a sandwich customization screen 702 is shown within an ordering interface screen 700. The selected restaurant item to be customized 708 appears at the top of the customization screen 702 with a listing of all customizable ingredients 706 for the selected restaurant item. Next to each customizable ingredient 706 is a series of selector boxes 704 representing various ingredient amounts such as standard, light, or none. When the customization screen 702 first appears, the selector boxes 704 will be set such that they represent a default setting for each customizable ingredient 706 according to a standard recipe for the selected restaurant item. A standard recipe selector 710 which returns all selector boxes 704 to their default settings and a plain selector 712 which removes all customizable ingredients 706 from the restaurant item are also provided on the customization screen 702. In one embodiment, the plain selector 712 can include indicia on or connected to the plain selector 712 which states “Make It Plain”. This “Make It Plain” indicia conveys to the customer that if the plain selector 712 is selected, the restaurant item that has already been selected for which the plain selector 712 is being selected, will cause the selected restaurant item to be customized to be plain, instead of having any condiments or customizable ingredients thereon, upon order fulfillment. In another embodiment, if the plain selector 712 is selected, the restaurant item that has already been selected for which the plain selector 712 is being selected, will cause the selected restaurant item to have all condiments, toppings and spreads removed (or not be included at preparation time) in a single step, instead of having to remove each, one at a time, through customization interface screen selections. In one embodiment, the resulting sandwich, for example, will only have a protein component (such as chicken) and a carrier component (such as a bun). If a restaurant item having cheese is selected, then the cheese will remain, in one embodiment, if the customer selects the plain selector 712 “Make It Plain” requests, as well as other customization requests, are received by the order taking application 310, 410 and conveyed to the POS system and order fulfillment systems described herein, for implementation of the customization requests.

As provided, the customer can interact with the selector boxes 704, standard recipe selector 710 and plain selector 712 to customize the customizable ingredients 706 for the selected restaurant item. The customization screen 702 also includes a cancel selector 714 and a finished selector 716 through which the customer can cancel the selection of a restaurant item or confirm the selection and customization of a restaurant item respectively. Once the customer either cancels or finishes the customization, the customization screen 702 disappears returning the customer to the standard ordering interface screen 700. The kiosk may also initiate a meal loop which will be described in detail below.

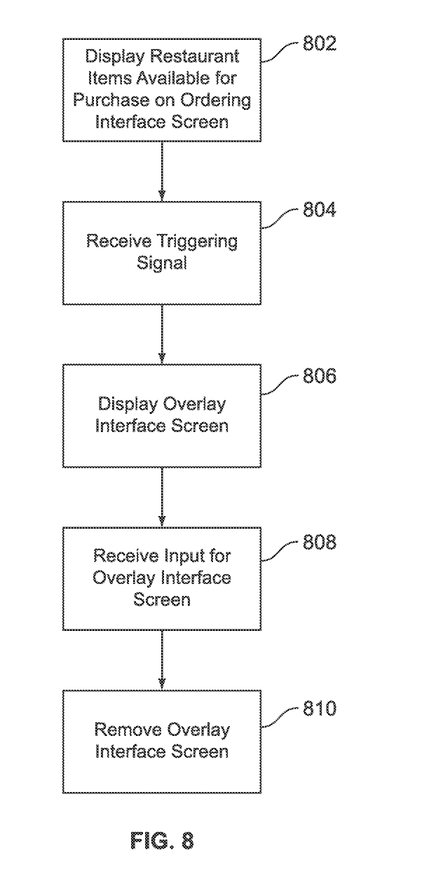

The customization outlined above is an example of a pop-up interface screen displayed by the kiosk 200 to elicit a certain input from the customer to streamline the ordering process. An embodiment of a process for displaying pop-up interface screens that aid customer ordering is shown in FIG. 8. In block 802, the kiosk 200 displays restaurant items available for purchase on the ordering interface screen 600. In block 804, the kiosk receives some sort of triggering signal. The triggering signal could be various customer inputs including, for example, selection of a restaurant item, completion of restaurant item customization, initiation of the payment process, timing out due to a period of inactivity from the customer, or other customer inputs. The customer order taking application 310, 410 can also be configured to generate and display a “cancel” selector, such as a: cancel” button, on each pop-up interface screen for the customer to choose to return to the other, non-pop-up, ordering interface screens. Once the cancel selector is selected by a customer, the order taking application 310, 410 generates and displays the other ordering interface screen, such as the last ordering interface screen that was present on the display prior to the specific pop-up interface screen being displayed on the display.

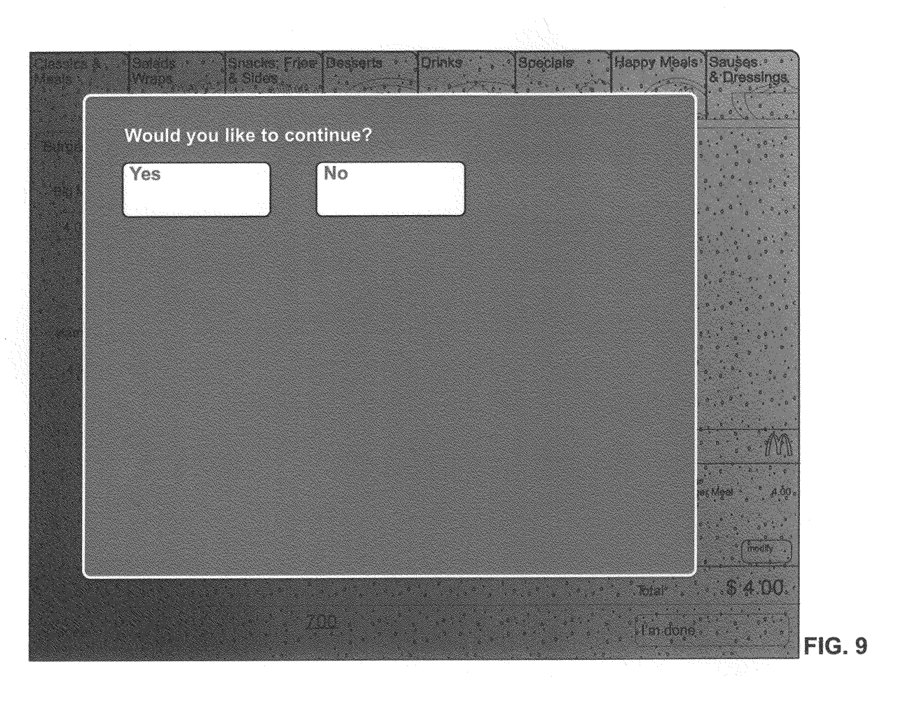

Returning to FIG. 8, once the kiosk has received a triggering signal, it will display a pop-up or overlay interface screen as shown in block 806. The overlay interface screen displayed will correspond to the triggering signal received and could be a customization screen as described above, a meal loop as described below, the payment process as described above or a timeout screen inquiring if the customer would like to continue ordering or start the ordering process over from the beginning as shown in FIG. 9. Pop-up or overlay interface screens can also include restaurant item promotion interface screens and error message interface screens.

In one embodiment, when displayed by the kiosk 200, the overlay interface screen appears to overlay the ordering interface screen 600, 700 via an optical illusion created by the kiosk 200. The overlay interface screen can vary in size and might take up the entire ordering interface screen or only a part thereof. While the overlay interface screen is being displayed, the ordering interface screen 600, 700 is disabled from receiving customer inputs and undergoes a change in visual appearance. For example, in FIG. 7, the change in visual appearance of the ordering interface screen 700 is darkening of the portion of the ordering interface screen 700 that still appears on the display. In another embodiment, the change in visual appearance may be changing from full color scale to grayscale. In block 808, the kiosk 200 receives a customer input through the overlay interface screen and then removes the overlay interface screen in block 810, which returns the ordering interface screen 600, 700 to normal appearance and functionality.

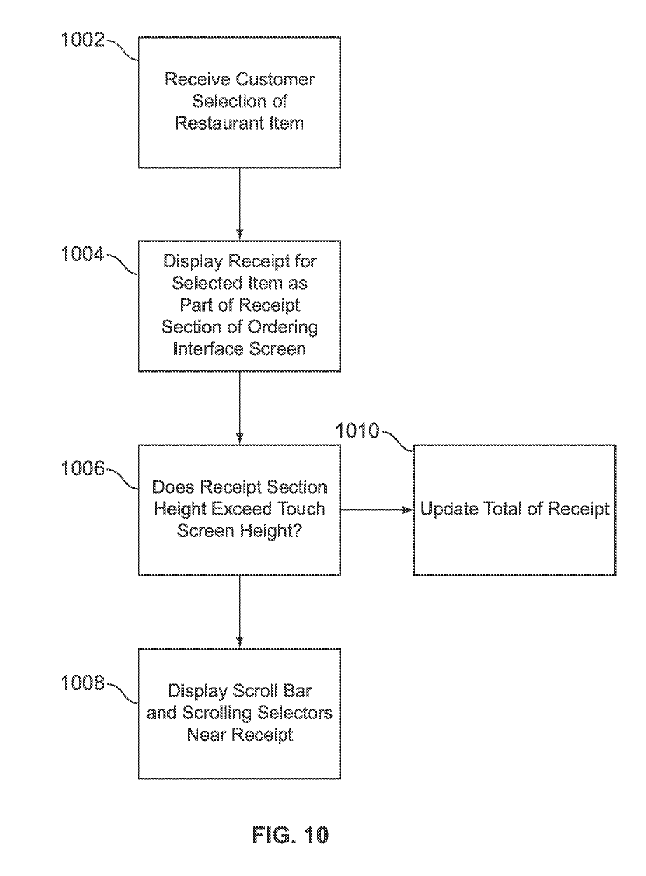

In one embodiment, all ordering interface screens 600, 700 that appear subsequent to the initial ordering interface screen 500 can include an updated electronic (virtual) receipt or order list 640 showing all restaurant items that have been selected by the customer so far within an order, as well as an order completion selector 642 which is used to end the restaurant item selection process and begin the payment process portion of the order. For example, referring now to FIG. 10, an embodiment of a process for generating an electronic receipt on the ordering interface screen 600 is shown. This electronic receipt information and process options therein allows the kiosk customer to view all restaurant items that have been selected, including an image or symbol of the selected restaurant item(s), which can be adjacent the identification, as well as the price of each selected restaurant item. The electronic receipt information and process options therein also allow the kiosk customer to select a customization option for each selected restaurant item listed within the electronic receipt to customize such restaurant item, as described herein, as well as an ongoing, real-time updated, total price for the selected restaurant items, with appropriate taxes included, as a running total. Additional electronic receipt process options can include an increment restaurant item number option to increase the number of that particular item that the customer wishes to order, by one for each selection, and a decrement restaurant item number option to reduce the number of that particular item that the customer wishes to order, by one for each selection. Each electronic receipt process information and option can be provided directly on each order tab, shown in at least FIGS. 6 and 7 as a rectangle having one type of order restaurant item or meal (and the number of the item type that was selected by the customer). The order tabs and totalization information together generally make up the electronic receipt or order list 640.

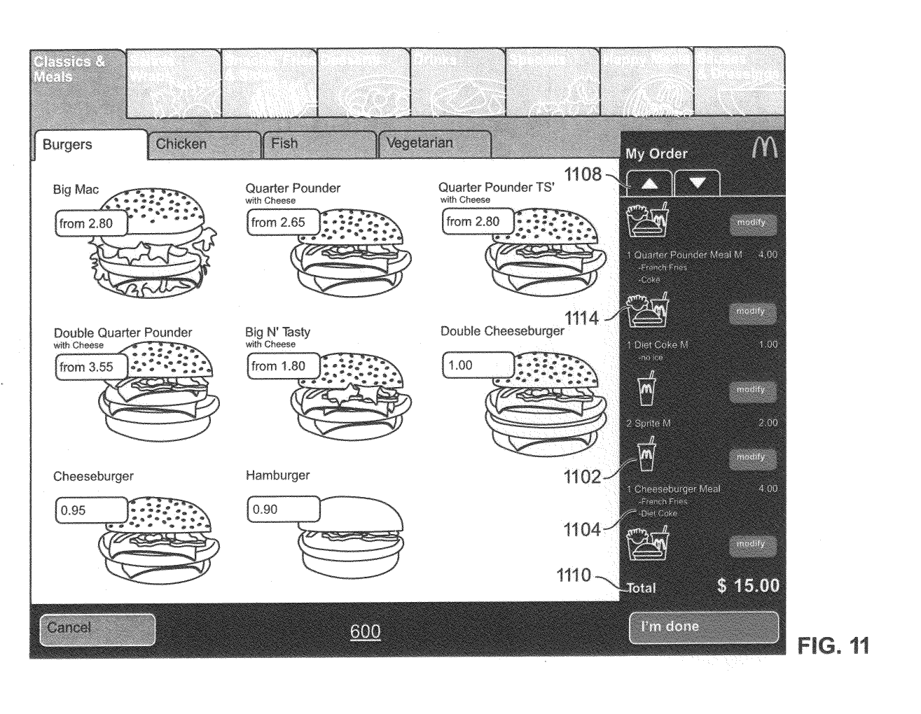

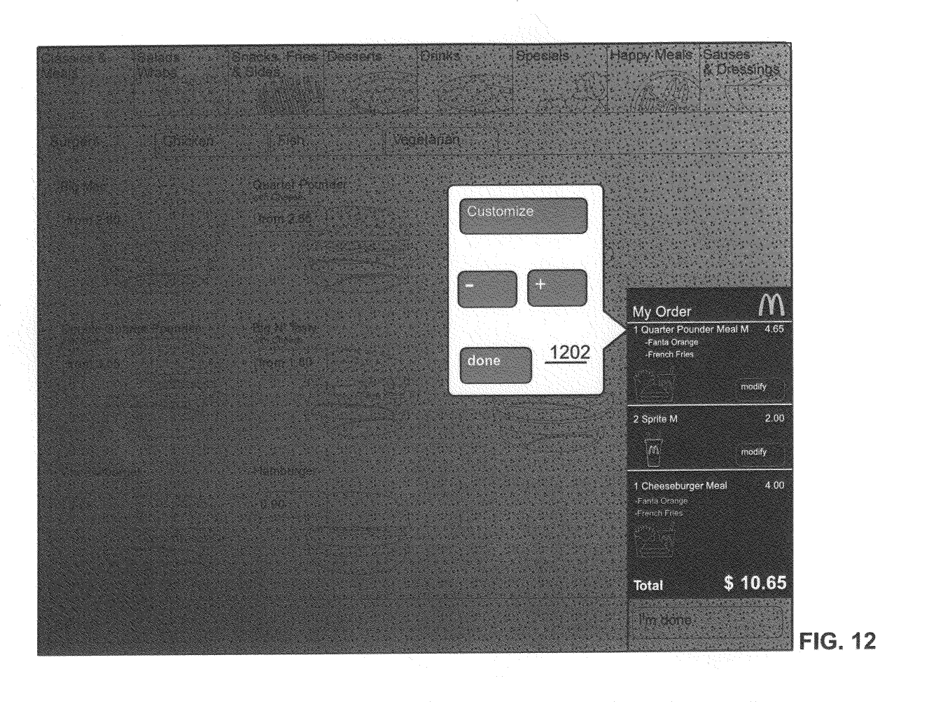

In block 1002, the kiosk 200 receives a customer's selection of a restaurant item through the ordering interface screens of the order taking application 410 displayed on the touch screen display 230. In block 1004, the kiosk 200 displays a receipt cell 1104 representing the selected restaurant item in the receipt area 1102 of the ordering interface screen 600. As shown in FIG. 11, a receipt cell 1104 for each selected restaurant item is displayed in the receipt area 1102 on the right side of the ordering interface screen 600. Each receipt cell includes the name and quantity of the selected restaurant item, any ingredient or dietary options customizations the customer has made, a representative icon 1114 of the selected restaurant item and a customization selector 1112 for making further customizations to the particular restaurant item. If the customer selects the customization selector 1112, as shown in FIG. 12 for example, a pop-up interface screen 1202 will be displayed allowing the customer to customize a particular aspect of the selected restaurant item including quantity, ingredients and/or dietary options before returning to the standard ordering interface screen 600.

As the customer selects restaurant items, a receipt cell 1104 is stacked onto the existing cells in the receipt area 1102, increasing the height of the receipt area 1102 and adding to the order total display 1110. For each additional selected restaurant item, the height of the receipt area 1102 continues to grow. In block 1006, the kiosk 200 determines whether the height of the receipt area 1102 exceeds a predetermined height threshold. If the height threshold is exceeded, then the kiosk 200 moves to block 1008 and displays the scrolling toggles 1108 as shown in FIG. 11. The scrolling toggles 1108 allow the customer to quickly view all receipt cells 1104 despite that fact that they may take up too much space to be viewed all at once on the ordering interface screen 600. In block 1010, the kiosk 200 displays an updated total amount due which is the aggregated prices of all selected restaurant items. When a customer has selected all restaurant items to be purchased, the customer interacts with the order completion selector 642 to initiate a payment loop which will be described in detail below. In one embodiment, the predetermined height threshold is the height of the interface screen display, the height of a portion of the interface screen display or some other height.

The present invention also allows the kiosk proprietor to limit the restaurant items available for purchase at any given time of day and allows a kiosk customer to quickly and easily toggle between various menu categories being offered including but not limited to breakfast, lunch, dinner and low-price or other type of menu. For example, within the same facility there may be a more traditional type of first quick service restaurant counter serving hamburgers, french fries, salads, apple slices, soft drinks, milk, juices, etc. through a first menu, while at the same there may also be a second quick service restaurant counter serving a coffee house type menu, such as premium coffee, muffins, wraps, health shakes, etc., through a second menu. Within the customer kiosk 110, 120, 130, 200, the first menu could be displayed through a first set of interface screens, and the second menu could be displayed thorough a second set of interface screens. Each different set of interface screens could be available at all times by selecting such interface screens through the customer kiosk 110, 120, 130, 200, one or more certain sets of interface screens may only be available at certain times of the day and/or week.

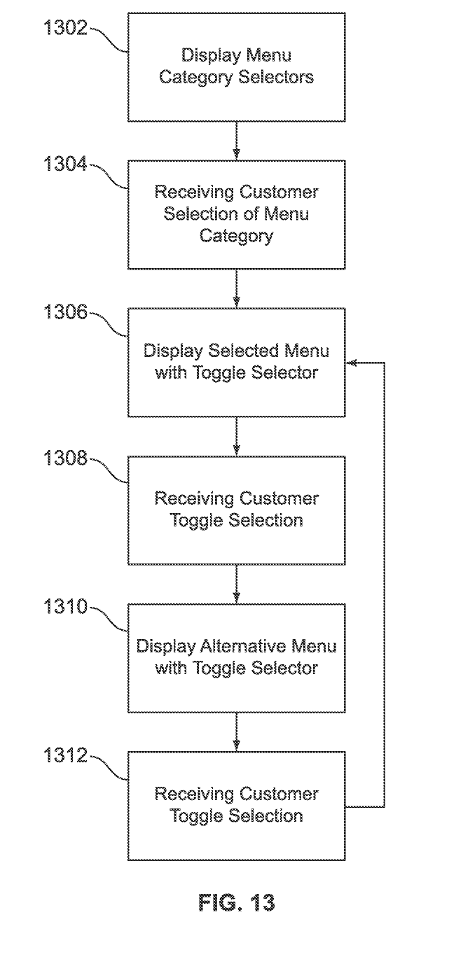

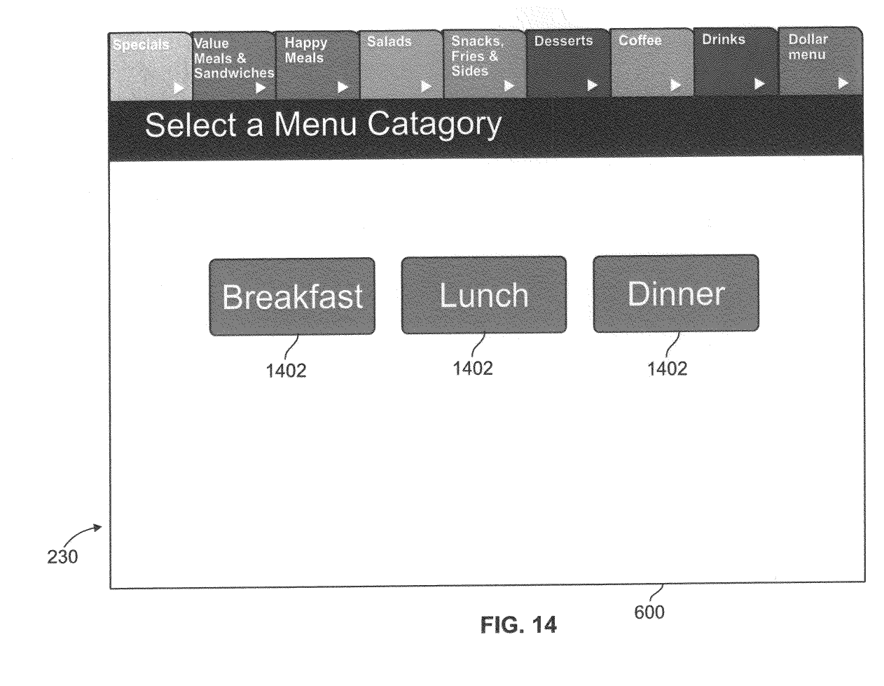

Referring now to FIG. 13, an embodiment of a process for presenting time specific menu categories is shown. First, in block 1302, the kiosk 200 displays a menu category selector 1402 on the touch screen display 230 for each menu category that is available at the current time of day as shown in FIG. 14. During some periods of time, only one menu category or menu type may be available. For example, in the morning hours of 6 A.M. to 10 A.M., only the breakfast menu category may be available, and in the afternoon hours of 12 noon to 4 P.M., only the lunch menu category may be available. However, during other periods of time more than one menu category may be available. For example, in the transitional time period of 10 A.M. to 12 noon, both breakfast and lunch menu categories may be available. Additionally, as described above, some menu categories, such as low-price, DOLLAR MENU, and/or coffee house type menus may be available at all times. The time periods that each menu category or type is available through a customer kiosk 110, 120, 130, 200 can be customized and set at and controlled by the local customer kiosk server 140 and respective local management computer 144.

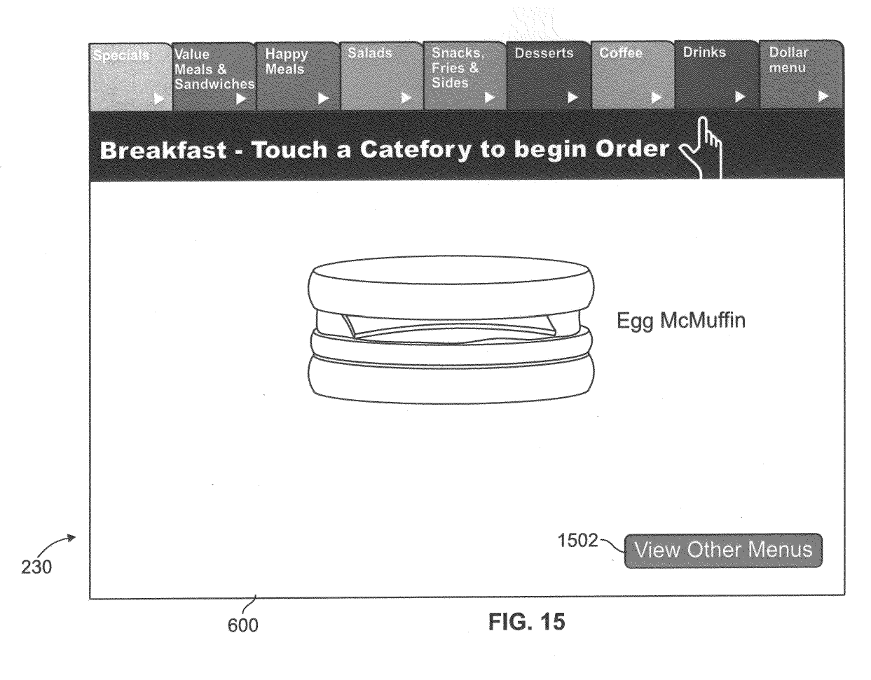

In block 1304, the customer selects a menu category or type by interacting with one of the menu category selectors 1402 on the touch display screen 230. At block 1306, the kiosk 200 displays the menu category that the customer selected along with a toggle selector 1502 as shown in FIG. 15. The toggle selector 1502 allows the customer to switch the menu category being viewed on the touch display screen 230 so that all restaurant items available for purchase at a given time may be found. This occurs beginning at block 1308, where the kiosk 200 receives a signal that the customer has selected an alternative menu category using the toggle selector 1502.

The kiosk 200 then displays the alternative menu category along with the toggle selector 1502 at block 1310. At block 1312, the kiosk 200 receives another toggle signal from the customer and the kiosk redisplays the originally selected menu category. Thus, the toggle selector 1502 enables a customer to place an order comprised of items from more than one menu category. For example, using the toggle selector 1502 a customer could order a breakfast sandwich from the breakfast menu category and fries from the lunch menu category on the same order. Many other examples come to mind, as one ordinary skill would understand from the present description.

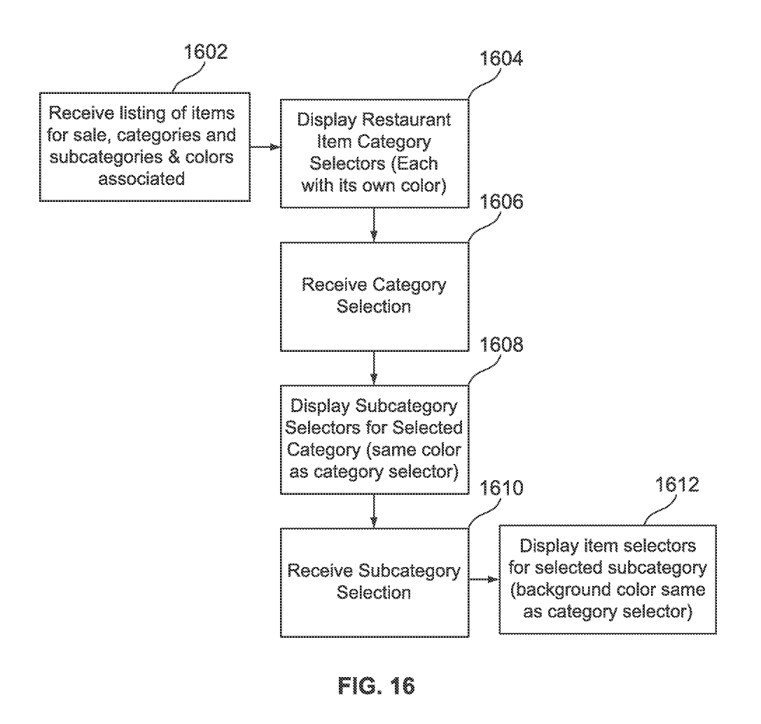

Kiosk customers are able to easily navigate the ordering interface screens of the order taking application 410 displayed on the touch screen display 230 through the association of a particular color or pattern with a specific group of restaurant items during the ordering process. For example, referring now to FIG. 16, an embodiment of a process of color coding restaurant item categories is shown. First, at block 1602, the kiosk 200 receives information regarding what restaurant items are available for sale, what item category and subcategory each restaurant item is categorized under and what background indicia is associated with each item category from the local customer kiosk server 140. Background indicia can be comprised of colors, patterns or other types of indicia. At block 1604, the kiosk application utilizes this information to display different category selectors 512 on the touch screen 230, and each restaurant item that is on sale is categorized within and by at least one category selector 512 as shown in FIG. 5. The categories defined can include but are not limited to value meals and sandwiches, kids meals, salads, snacks, fries and sides, desserts, coffee, drinks and low price menu. In one embodiment, the background indicia does not have to be behind the restaurant menu item selectors. For example, the background indicia can take the form of the name of one or more of the subcategory selectors 604, 608, 612, 614, described below. In one particular embodiment, the color of the name of the subcategory selectors 604, 608, 612, 614 is the same as the color of the associated category selector for subcategory selectors 604, 608, 612, 614 (which can be completely different from the color that is behind the name of the subcategory selectors 604, 608, 612, 614). Other associations between a category, subcategories within such category, and/or restaurant items within such category and subcategories can be established using graphic treatments that clearly associate a color or other indicia pattern between such category, subcategories within such category, and/or restaurant items within such category and subcategories.

The category selectors 512 are displayed by the kiosk 200 as a part of its ordering interface screen 230. As shown in FIG. 5, each category selector 512 is manifested/ displayed on the ordering interface screen 230 with the name of the represented category and the background indicia 634 associated with that category. In the present embodiment, each category selector is an independent rectangular panel on the ordering interface screen filled in with the solid color associated with each particular category. However, those of ordinary skill in the art will understand that the category selectors could be manifested on the ordering interface screen in a variety of ways without departing from the novel scope of the present invention.

After a customer selects a category via one of the category selectors 512 at block 1606, the kiosk 200 receives the selection signal and displays the appropriate set of subcategory selectors 604, 608, 612, 614 associated with the selected category at block 1608. For example, the subcategories associated with the meals and sandwiches category in the present embodiment are burgers, chicken, fish and vegetarian. Each subcategory selector 604, 608, 612, 614 represents a restaurant item subcategory within the selected category and is manifested on the ordering interface screen 230 with the name of the represented subcategory and the same background indicia 634 associated with the selected category as shown in FIG. 6. In the present embodiment, the subcategory selectors 604, 608, 612, 614 are rendered as smaller rectangles that appear below the category selectors but one of ordinary skill in the art will understand the subcategory selectors 604, 608, 612, 614 could be manifested in a variety of shapes without departing from the novel scope of the present invention.

Next, at block 1610, the customer selects a restaurant item subcategory on the ordering interface screen 600. Once the kiosk 200 has received the selection signal, it will display the set of restaurant item selectors 638 associated with the selected subcategory at block 1612. The restaurant item selectors 638 may be displayed on a part of the ordering interface screen 600 or on a separate overlay interface screen. Each restaurant item selector 638 is representative of a restaurant item available for purchase and is displayed on a background of the background indicia 634 associated with the previously selected category and has that same background indicia 634 as its own background as shown in FIG. 6. Each selector 638 can contain the price of the restaurant item it represents or a suggestive message, which may be for example “I'll Take It.” However, one of ordinary skill in the art will understand that any suggestive message may be included within the restaurant item selector 638 without departing from the novel scope of the present invention.

Additionally, each restaurant item selector 634 is displayed in conjunction with an icon or image 636 representative of the corresponding restaurant item. The icon 636 can take various forms including but not limited to a polygon, a three dimensional shape or an enclosed perimeter shape. The restaurant item selector 638 is displayed at least in part inside the same area as the representative icon 636 is displayed giving the visual effect that the restaurant item selector 638 is touching or overlapping its corresponding representative icon 636. Thus, by editing the restaurant item selector 638, the price of a restaurant item may be changed without changing the representative icon 636.

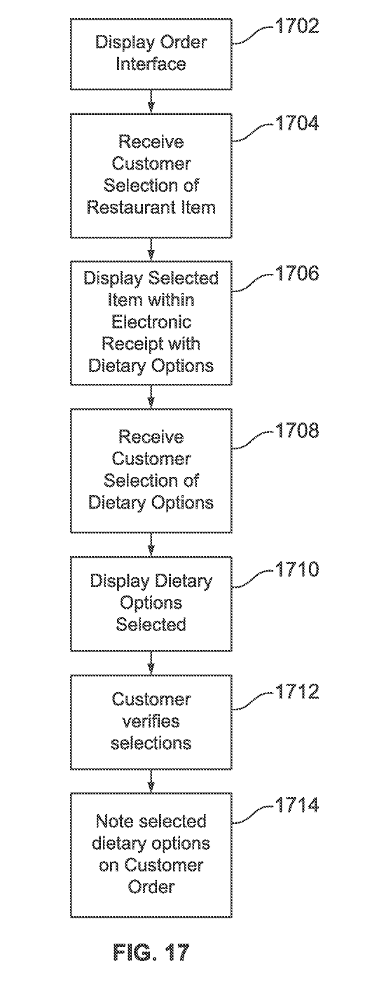

Once a restaurant item is selected by the customer, the kiosk provides numerous opportunities for the customization of the selected item at appropriate places/locations within the flow of the various customer interface screens, including the pop-up screens. For example, referring now to FIG. 17, an embodiment of a process of using selector boxes 704 to indicate customization of ingredients based on dietary needs on a purchased restaurant item is shown. This embodiment allows a kiosk customer to efficiently select a predetermined set of ingredients for a restaurant item to be purchased in accordance with the customer's preferences or dietary needs. At block 1702, the kiosk 200 displays the ordering interface screen on its touch screen display 230. At block 1704, the kiosk 200 receives a signal indicating a customer's selection of a restaurant item via the customer's interaction with the interface screens of the order taking application 410.

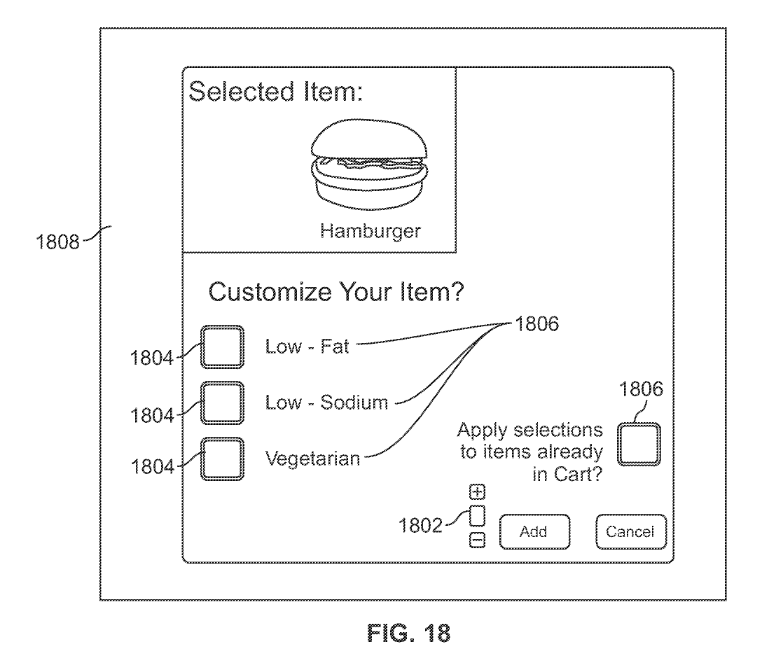

During block 1706, as shown in FIG. 18, the kiosk 200 displays the selected restaurant item in an order cart interface screen 1802. In the present embodiment, the kiosk 200 displays the order cart interface screen 1802 as a pop-up overlay interface screen on the ordering interface screen 600. The order cart interface screen 1802 appears to overlay a darkened ordering interface screen 1808. The order cart interface screen 1802 also includes at least one selector box 1804 that represents a dietary option 1806. A dietary option 1806 is a predetermined set of ingredients that are in accordance with known common preferences or specific nutritional or dietary goals. Selectable dietary options 1806 can include but are not limited to low-fat, low-sodium, sugar-free, light, regular, low-cholesterol and vegetarian. Each restaurant item may have a different set of dietary options associated with it.

Additionally, a selector box 1804 representing the option of applying the selected dietary options 1806 to all selected restaurant items may also be present on the order cart interface screen 1802. The customer selects one or more dietary options 1806 using the corresponding selector boxes 704 in block 1708 and the kiosk 200 displays the selected dietary options 1806 on the order cart interface screen 1802 in block 1710. Finally, once the kiosk 200 has received customer verification of the selected dietary options 1806 in block 1712, it incorporates the selected dietary options 1806 into the customer's order in block 1714.

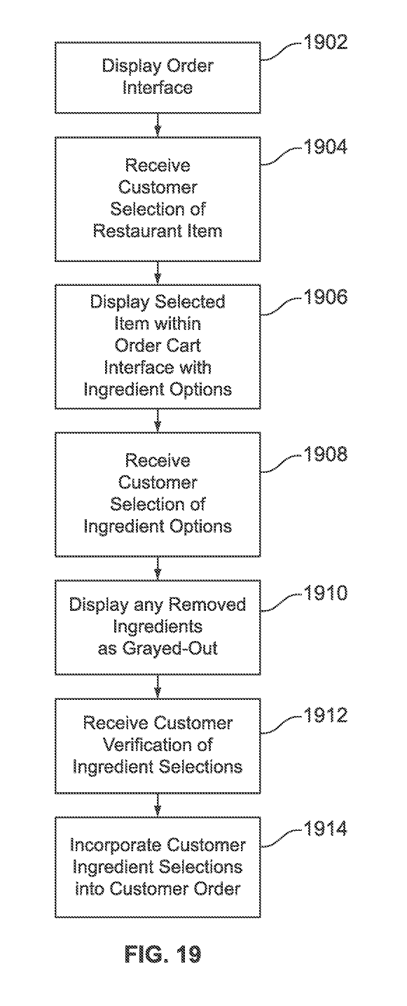

Referring now to FIG. 19, an embodiment of a process of using selector boxes 704 to customize ingredients and side items on a purchased restaurant item is shown. This embodiment allows a kiosk customer to easily customize each restaurant item purchased according to the customer's preferences. At block 1902, the kiosk 200 displays the ordering interface screen on the touch screen display 230. At block 1904, the kiosk 200 receives a signal indicating a customer's selection of a restaurant item via the customer's interaction with the interface screens generated by the order taking application 410.

During block 1906, as shown in FIG. 7, the kiosk 200 displays the selected restaurant item in a customization screen 702. The customization screen 702 also includes at least one selector box 704 that represents an ingredient option 706. In the present embodiment, multiple selector boxes 704 representing multiple ingredient options 706 are provided depending on the nature of the restaurant item selected. Ingredient options 706 can be comprised of condiments, sides and/or toppings for the selected restaurant item and give the customer a choice of how much, if any, of each represented ingredient should be on the restaurant item to be purchased.

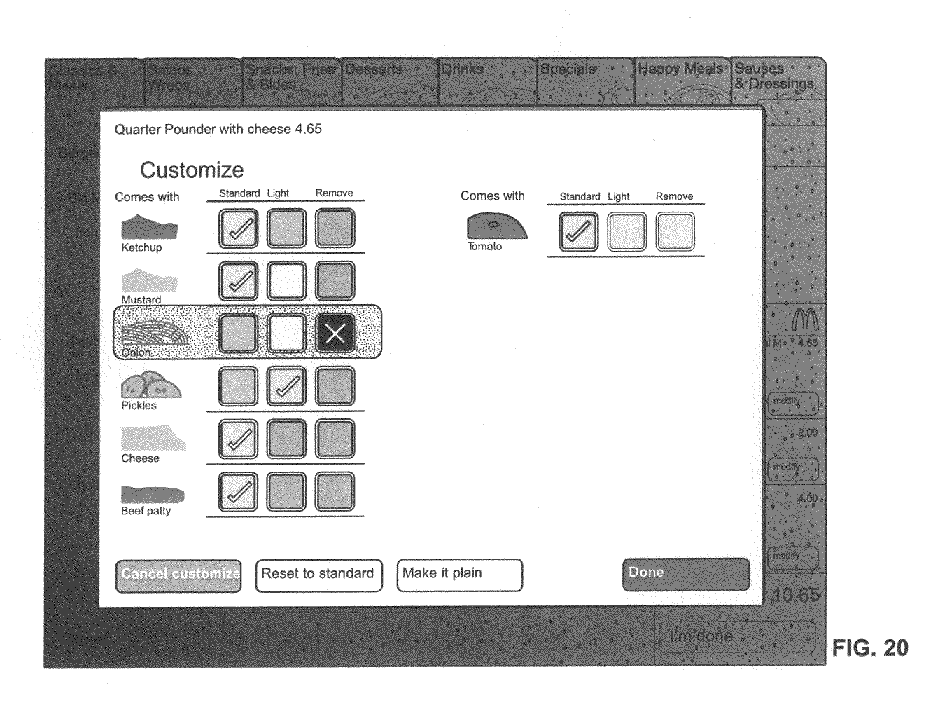

The customer selects one or more ingredient options 706 using the corresponding selector boxes 704 in block 1908 and the kiosk 200 displays the selected ingredient options 706 on the customization screen 702 in block 1910 as shown in FIG. 20. FIG. 20 also shows that any ingredients that have been removed entirely from the restaurant item are displayed by the kiosk 200 as grayed-out to indicate to the customer that the ingredient will no longer appear on the selected restaurant item. Graying out is but one example of visually displaying a change to the appearance of the ingredient, such that the customer can visually decipher that the ingredient has been removed. Other examples can include at least cross-out patterns or indicia as well as striped patterns or indicia overlaying the ingredient. Finally, once the kiosk 200 has received customer verification of the selected ingredient options 706 in block 1912, it incorporates the selected ingredient options 706 into the customer's order in block 1914.

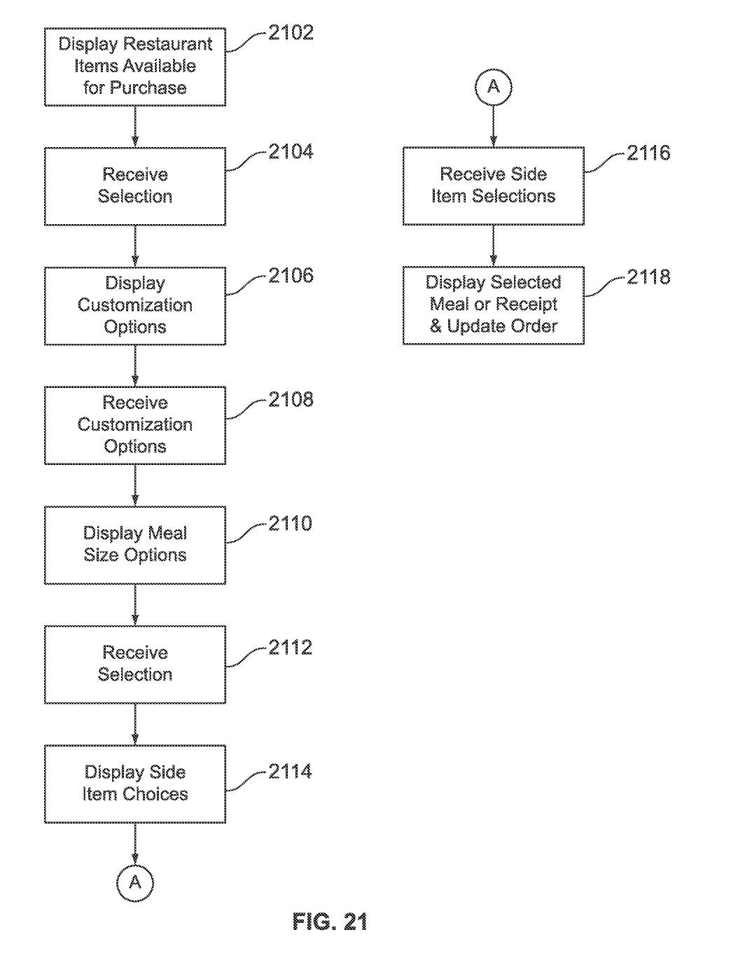

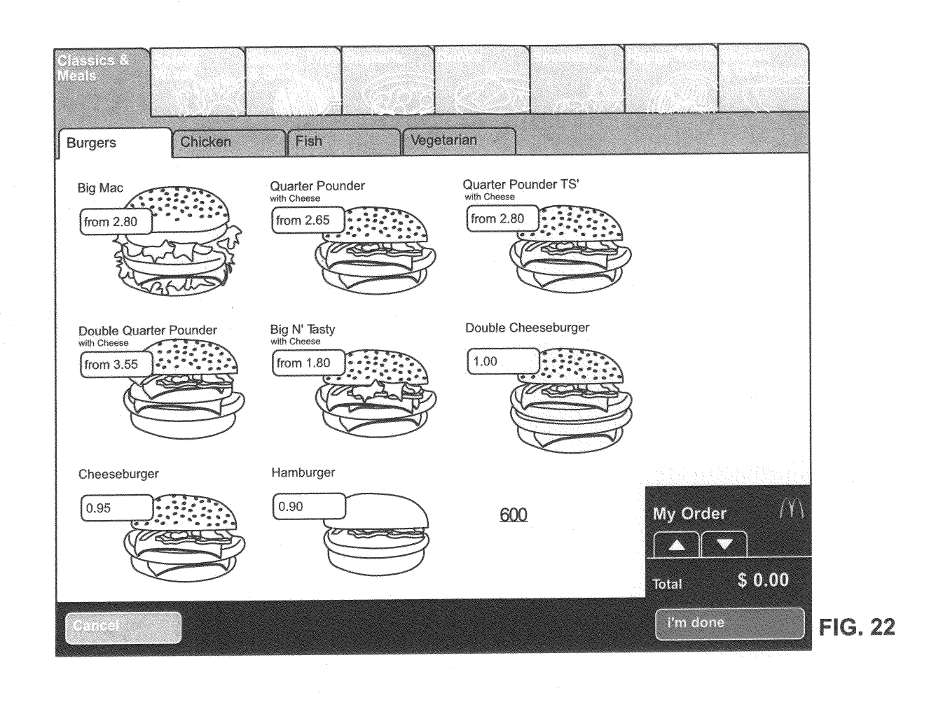

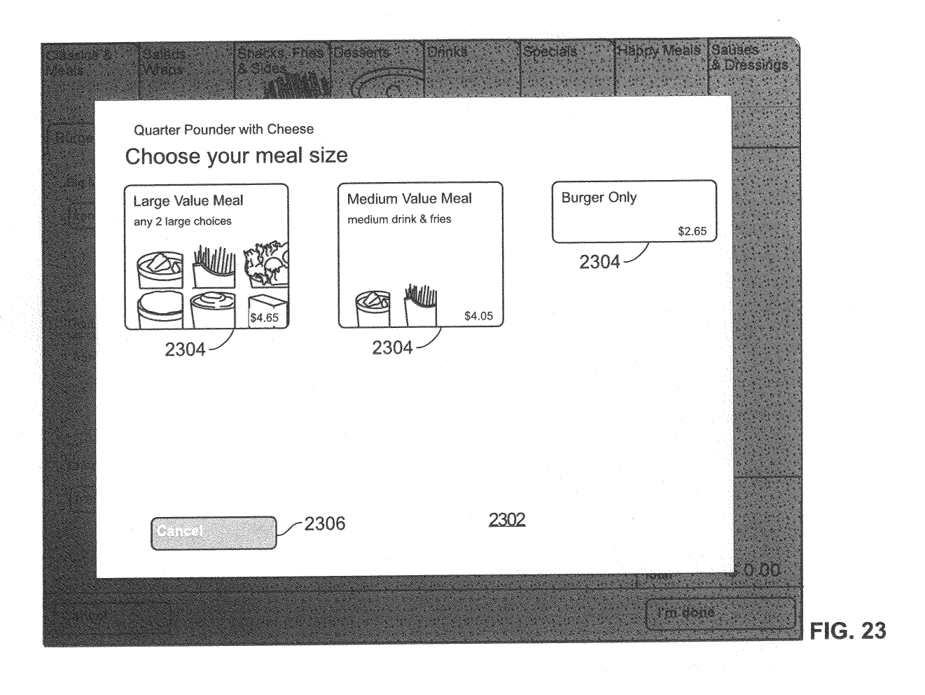

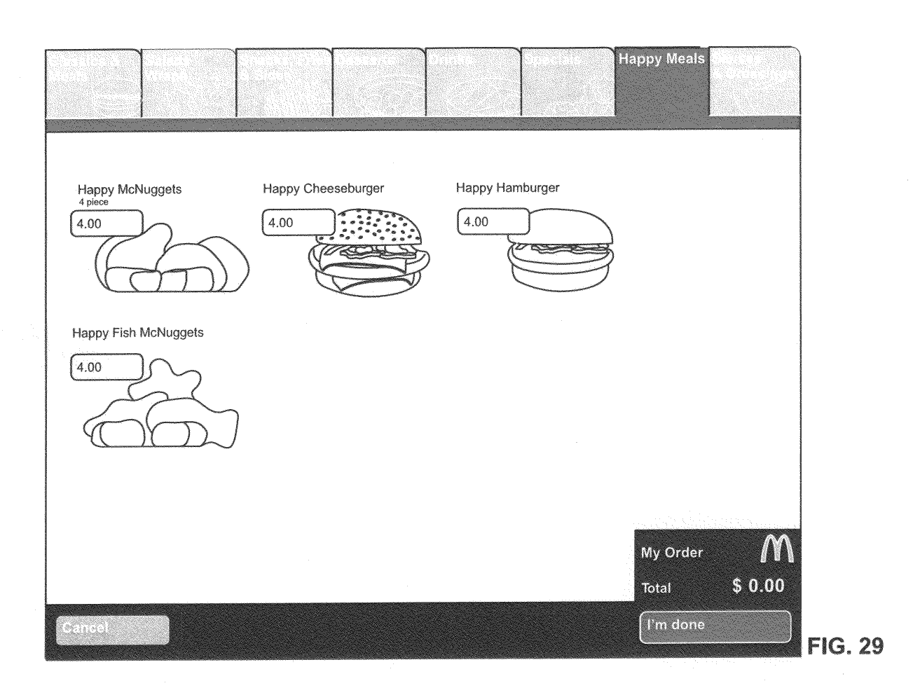

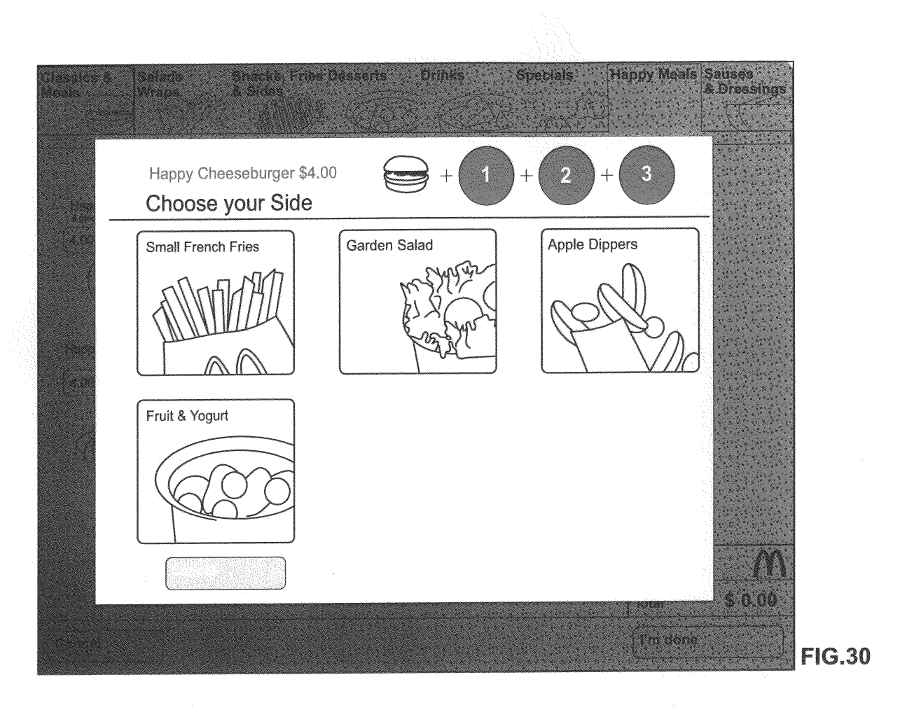

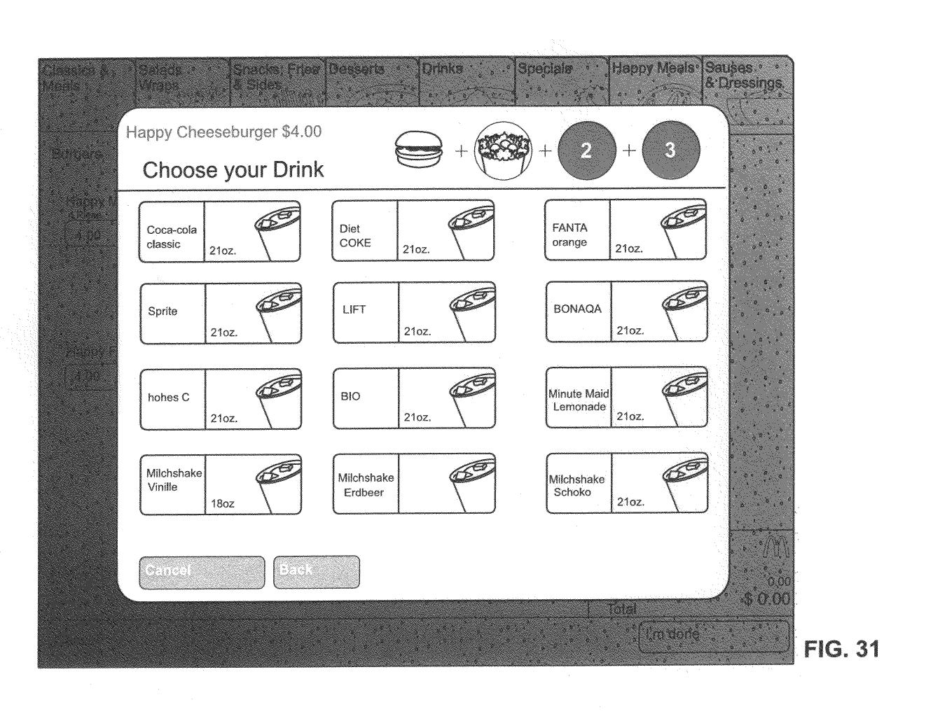

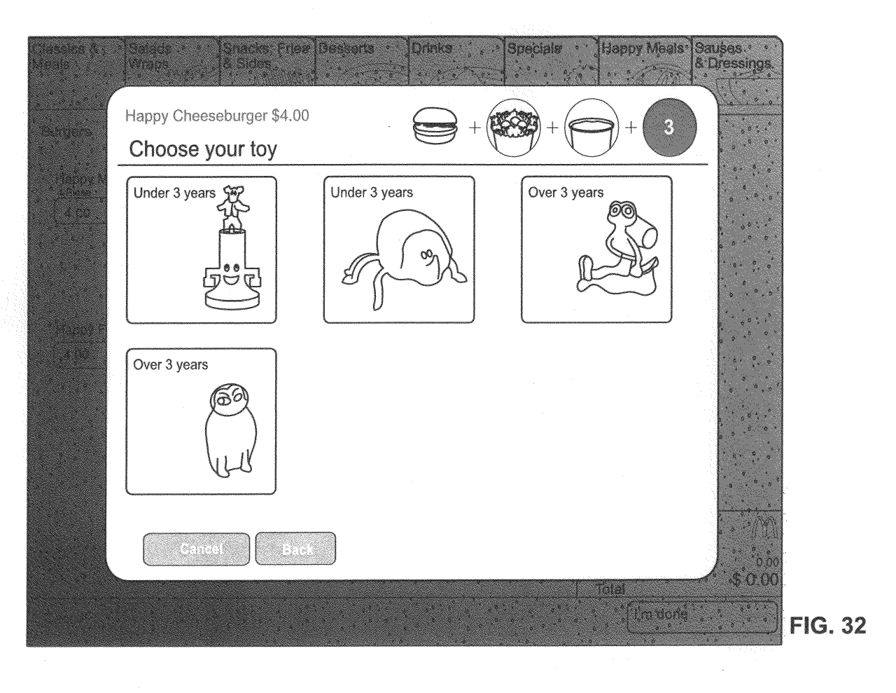

Once the customer has finished selecting and customizing a restaurant item, the kiosk 200 may initiate a meal loop to streamline the ordering process. Meal loops can be initiated for at least VALUE MEALS as shown in FIGS. 21-28 and HAPPY MEALS as shown in FIGS. 29-32. Referring now to FIG. 21, an embodiment of a process of streamlining customer ordering using a meal loop is shown. In block 2102, the kiosk 200 displays restaurant items available for purchase on an ordering interface screen 600 as shown in FIG. 22. In blocks 2104, 2106 and 2108 the kiosk 200 receives a customer selection signal, displays customization or product bundling options and receives customization or product bundling signals as detailed above. As shown in FIG. 23, in block 2110, the kiosk displays a meal loop screen 2302 as an overlay interface screen. The kiosk 200 displays various meal choice selectors 2304 on the meal loop screen 2302 as well as a cancel selector 2306. These selectors allow the customer to choose to make a VALUE MEAL of varying size, order only the restaurant item selected or cancel and return to the ordering interface screen 600.

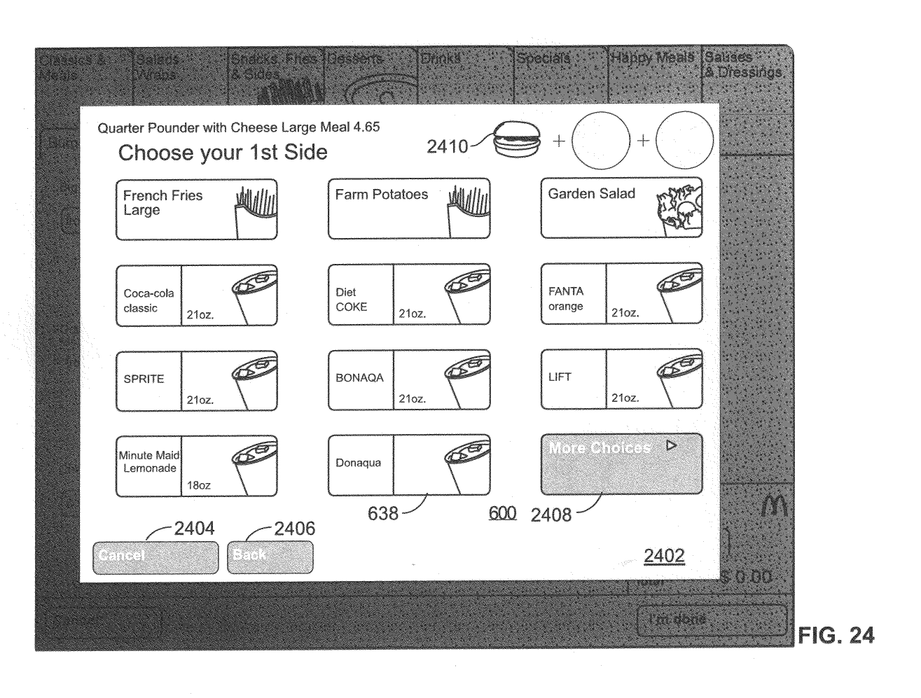

If the customer elects to make a meal at block 2112, then at block 2114, the kiosk 200 displays a side item selection screen 2402 as shown in FIG. 24. The side item selection screen 2402 allows the customer to select side items and drink items that will complete the selected meal. The side item selection screen 2402 contains a cancel selector 2404 to escape the meal loop process, a back selector 2406 to return to the previous meal loop screen and various restaurant item selectors 638 that represent restaurant items classified as side items. If the amount of displayed restaurant item selectors 638 is too great to fit on the side item selection screen 2402, a more choices toggle 2408 will be displayed which allows the customer to toggle between multiple sets of restaurant item selectors 638.

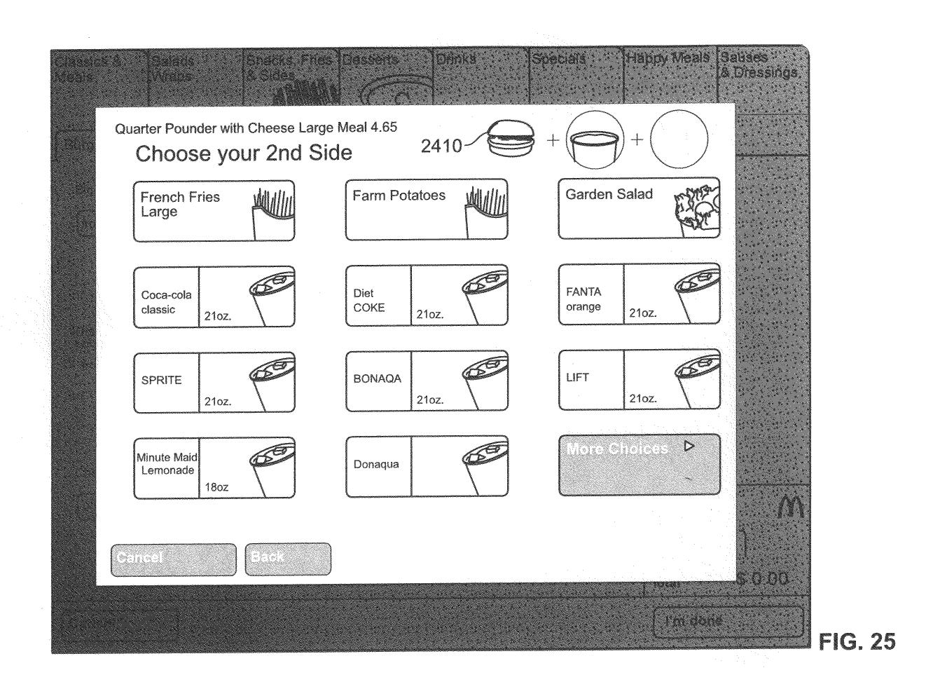

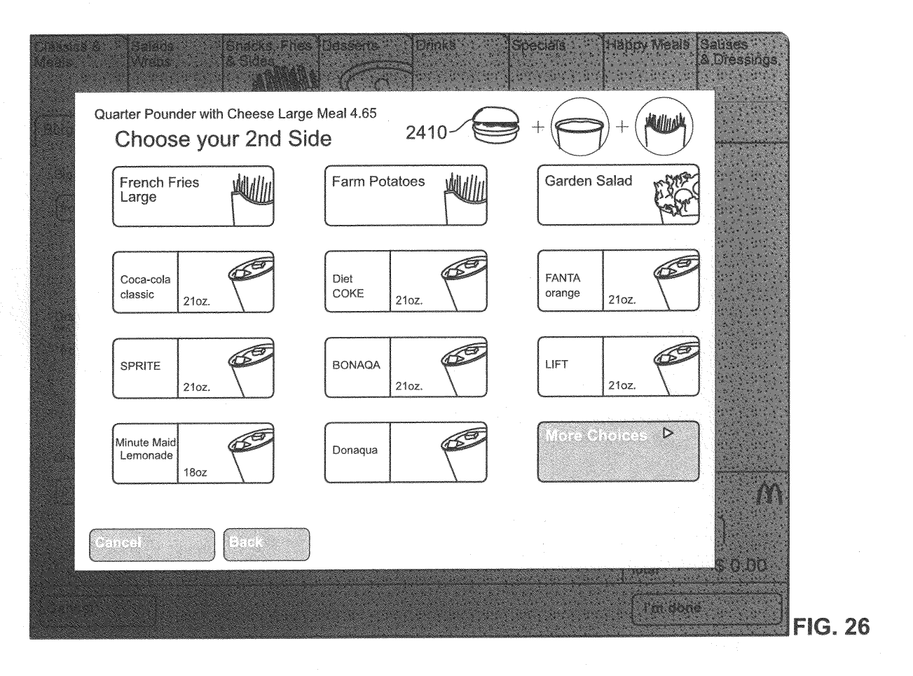

Additionally, a meal status bar 2410 is also displayed on the side item selection screen 2402. The meal status bar 2410 is composed of a series of icons equal in number to the number of restaurant items to be selected in the meal the customer selected on the meal loop screen 2302. Where no restaurant item has been selected for a meal, each icon displayed is a generic shape as a place holder for each restaurant item to be selected to complete the selected meal. Once a meal restaurant item has been selected, a representative icon of that restaurant item is displayed in place one of the place holder icons. For example, in FIG. 24, a Quarter Pounder with Cheese Large Meal was selected but no sides have yet been selected. Thus, the meal status bar has three total icons since the large meal comes with two sides, one of which is a Quarter Pounder with Cheese icon and the other two are gray circles with numbers inside of them indicating how many items are left to be selected in the meal. As shown in FIGS. 25-26, as the customer selects side items, the gray circles are replaced with representative icons of the selected restaurant items. As a result, at any time in the meal loop process, the customer can quickly determine what restaurant items have already been selected and how many more restaurant items need to be selected before the meal is complete.

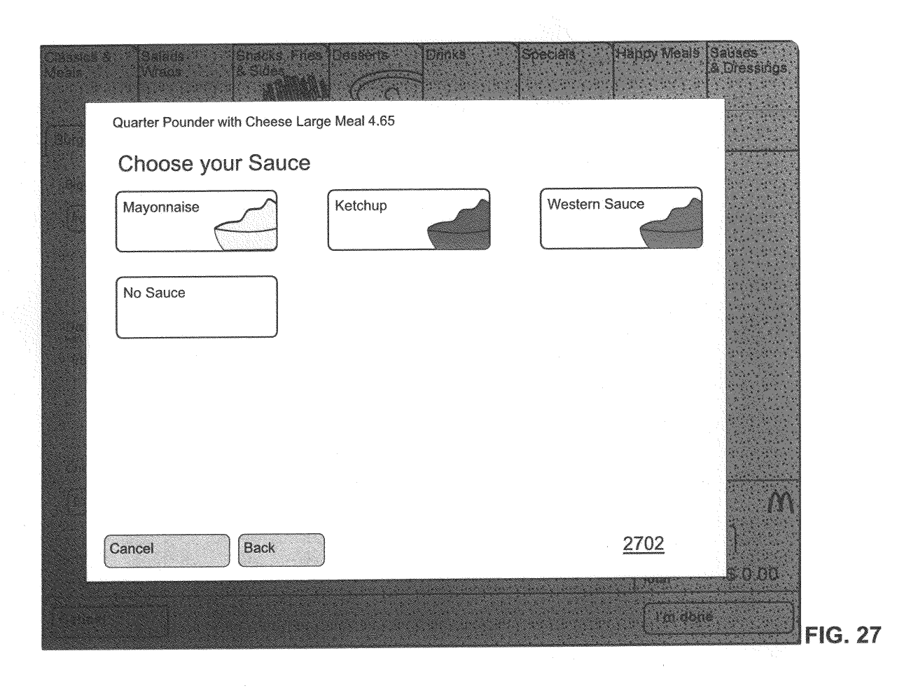

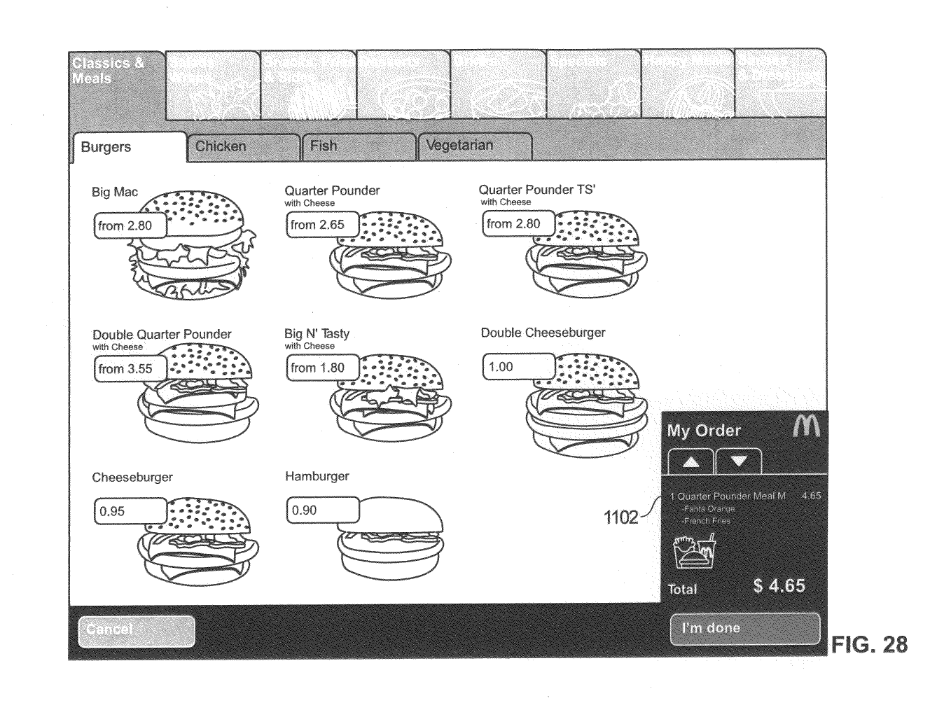

At block 2116, the kiosk 200 receives the customer side item selections through the interaction with the side item selection screen 2402. When certain side items are selected, the kiosk may display a side item customization screen 2702 such as the sauce selection screen as shown in FIG. 27. Once all meal items have been selected and customized, in block 2118, the kiosk 200 updates the customer order, stops displaying the meal loop overlay interface screens and displays the completed meal on the receipt area 1102 on the ordering interface screen 600 as shown in FIG. 28. The meal loop process for HAPPY MEALS is nearly identical to the above outlined process with the additional step of toy selection. Screenshots depicting this process are shown in FIGS. 29-32.

However, the meal loop processes outlined above are not the only forms that meal loops may take. A meal may be selected by choosing each meal item individually through the ordering interface screen 600 and customizing all selected items at once. Alternatively, customization could occur for each selected item individually immediately after selection. Additionally, a meal may be selected by choosing a combo selector, selecting a beverage type and customizing all items at once. For this type of meal formation, options to purchase extra add-on ingredients may also be offered thus allowing the customer to control the number of items included in the meal.

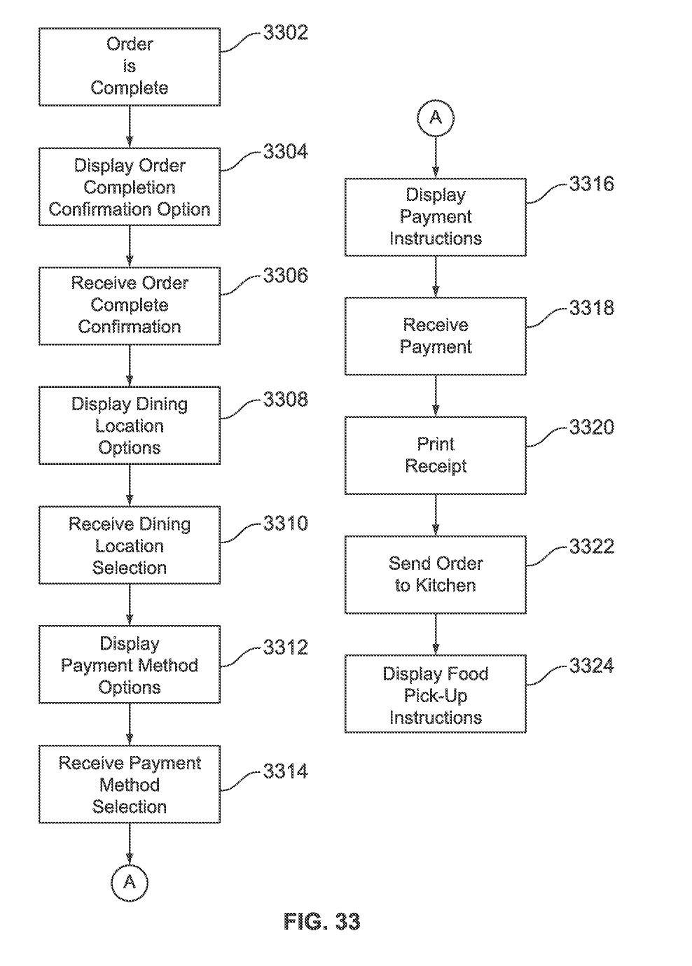

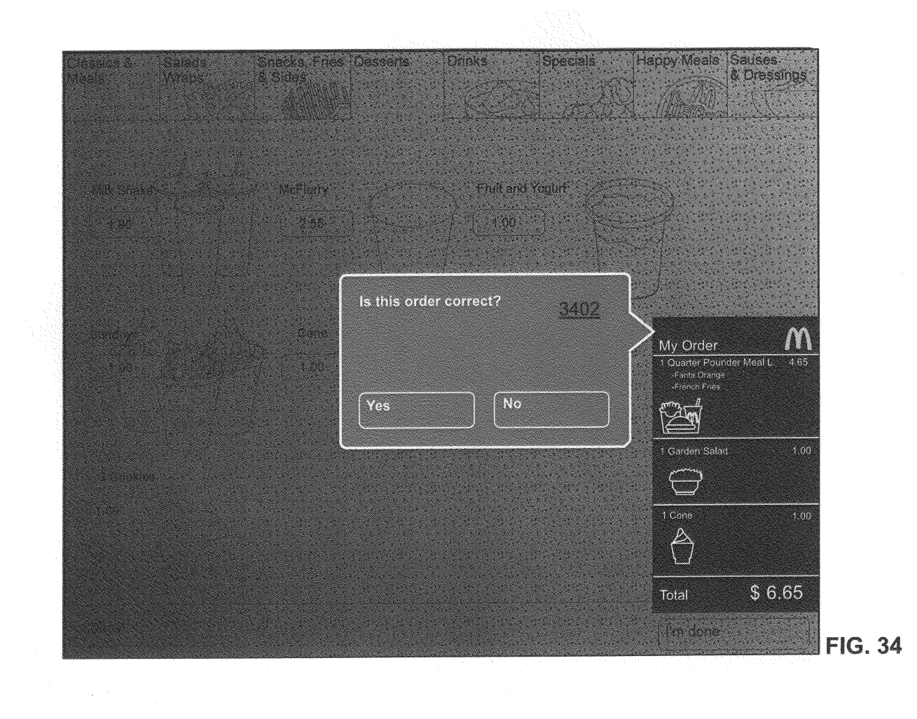

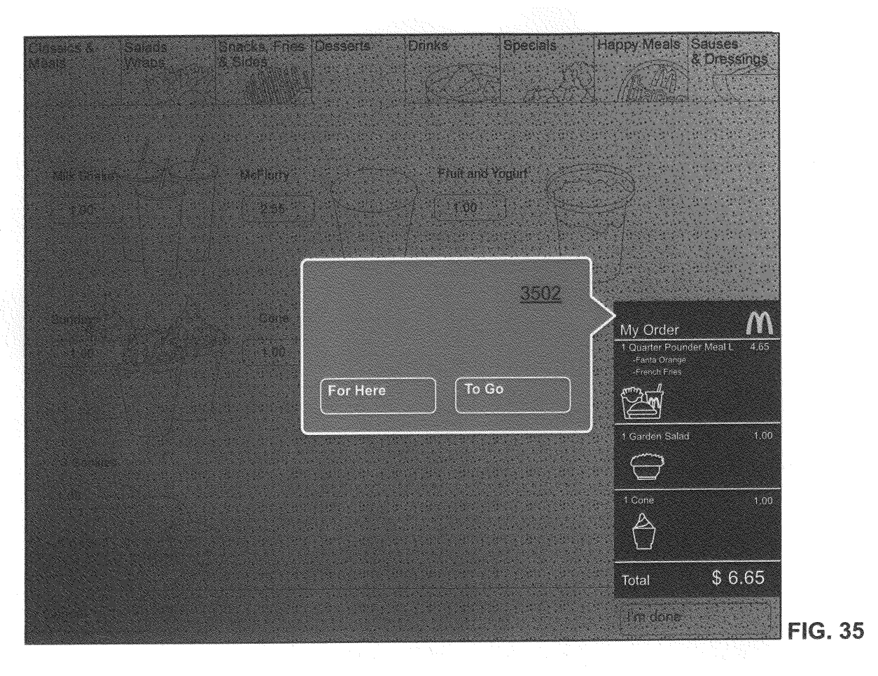

Finally, once the customer has finished selecting restaurant items and is ready to complete the order, the order completion selector 642 is selected on the ordering interface screen 600. In one embodiment, the order completion selector 642 can include indicia which asks “Is the Order Correct?”, as shown. Referring now to FIG. 33, an embodiment of a process of order confirmation and payment loop is shown. This process streamlines the end of the ordering process. In block 3302, the kiosk 200 receives a signal that the customer wishes to complete the order. The kiosk 200 displays an overlay interface screen called an order confirmation interface 3402 in block 3304 as shown in FIG. 34. The order confirmation interface 3402 asks the customer if the order is truly complete. Once the kiosk 200 receives the confirmation signal that the order is in fact complete in block 3306, it displays a dining location interface 3502 in block 3308 as shown in FIG. 35. The dining location interface 3502 presents the customer with dining location options such as “For Here” or “To Go.” The customer's dining location selection is received by the kiosk 200 in block 3310. In one embodiment, the order taking application 310, 410 can instead generate and display “Eat In” or “Take Out” language as separate options for the customer to select from. Other language can be used instead, such as “Dine In” or “Carry Out.”. In any of these embodiments, the order taking application 310, 410 can be configured to generate and display these dining location options after the first restaurant item is selected, and prevent the customer from selecting a second restaurant item until a choice of a dining location is made by the customer through the customer kiosk 110, 120, 130, 200. In another embodiment, the order taking application 310, 410 can be configured to generate and display these dining location options only after the customer has input that they have completed their order and are ready to pay, but prior to paying for the order, thereby preventing the customer from paying for the order until a choice of a dining location is made by the customer through the customer kiosk 110, 120, 130, 200. In a further embodiment, the order taking application 310, 410 can be configured to generate and display these dining location options before the customer has selected a first restaurant item, thereby preventing the customer from ordering a first restaurant item to include within the order until a choice of a dining location is made by the customer through the customer kiosk 110, 120, 130, 200.

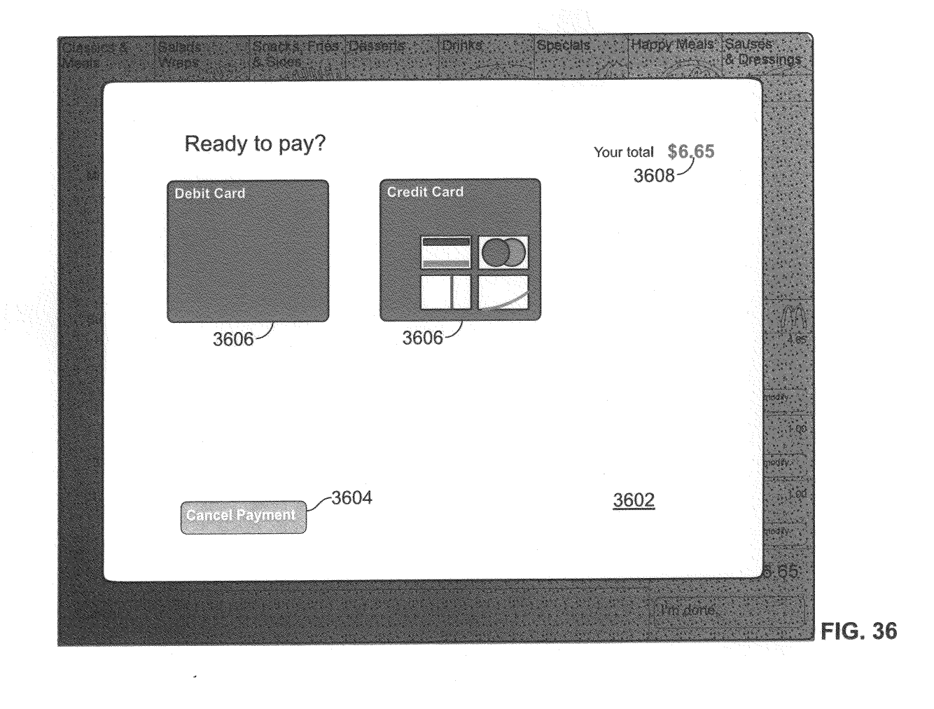

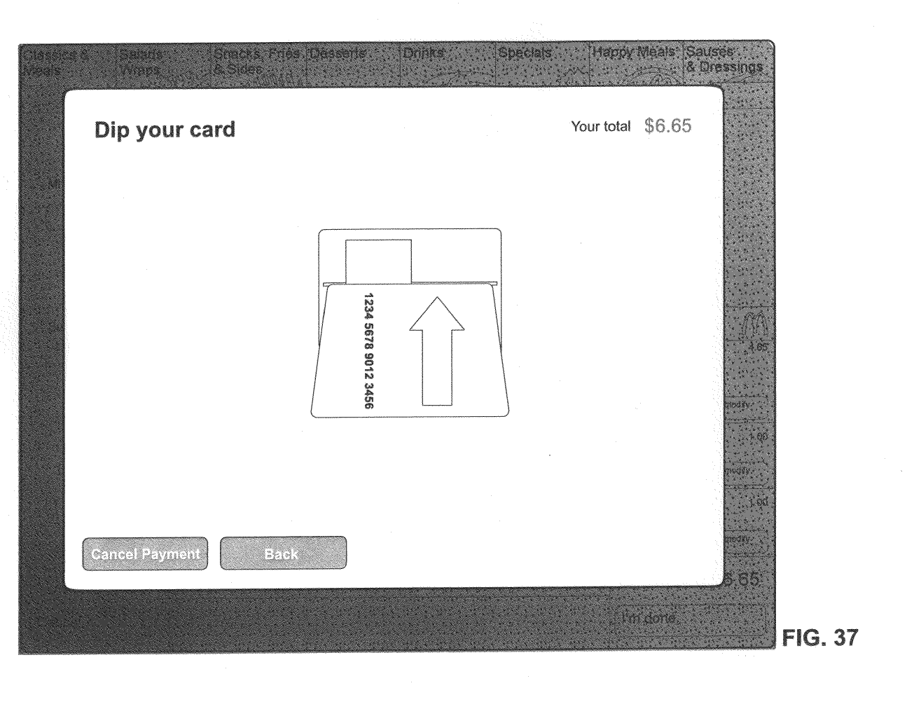

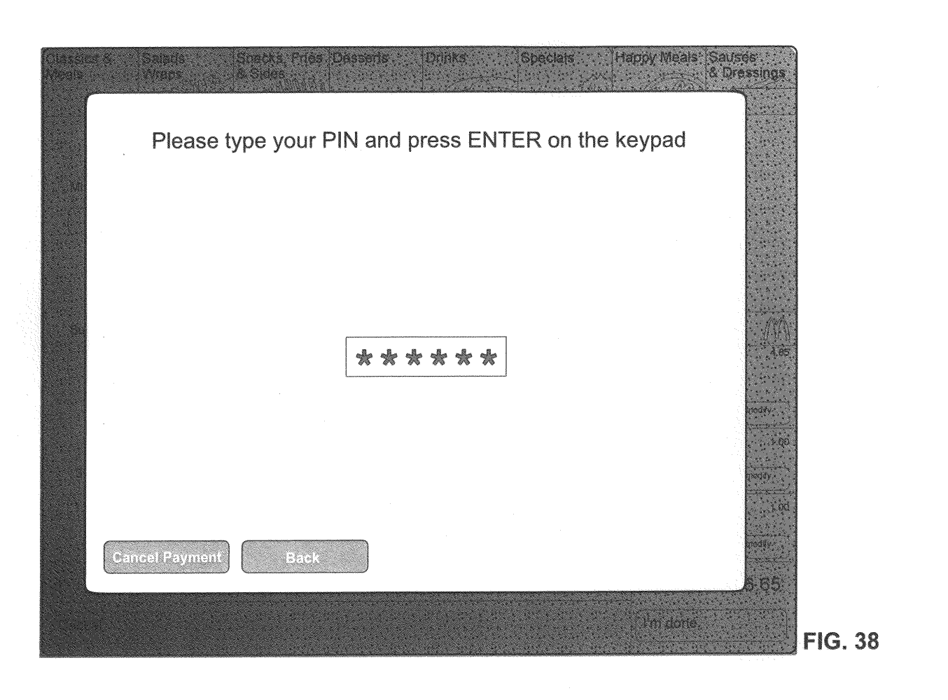

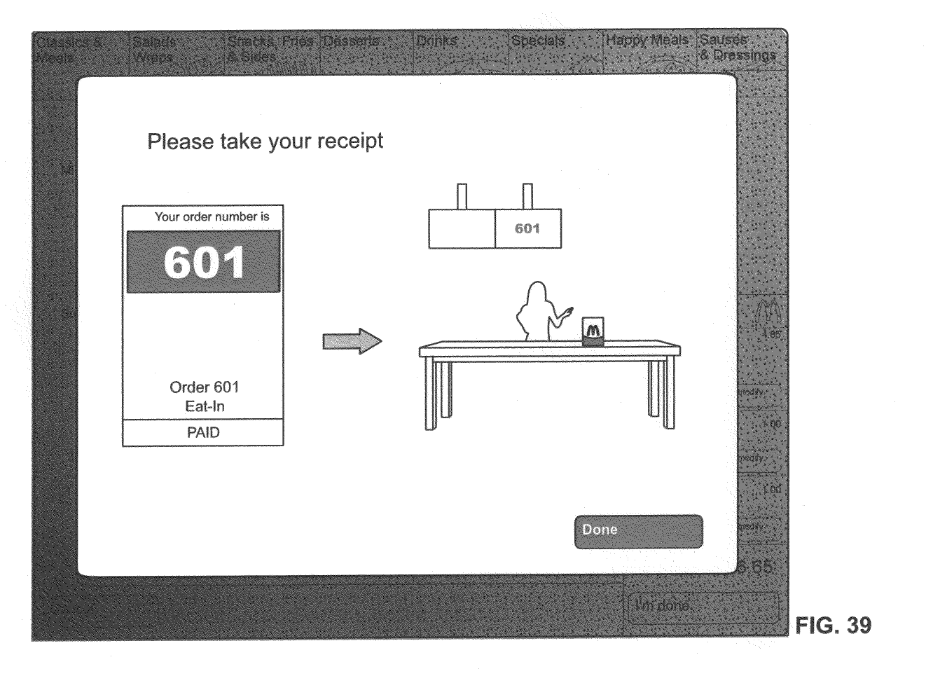

In block 3312, the kiosk initiates a payment loop. As shown in FIG. 36, the kiosk displays a payment loop interface 3602 which contains the total order cost 3608, a cancel payment selector 3604 and various payment method selectors 3606. Each payment method selector 3606 represents an accepted method of payment at the kiosk 200 and could include cash, debit card, credit card, gift card and/or coupon redemption. Once the kiosk 200 receives a payment method selection in block 3314, it displays instructions on how to complete a payment using the selected payment method in block 3316 as shown in FIGS. 37-38. After payment is received in block 3318, the kiosk 200 prints the customer's receipt in block 3320 which is dispensed through the receipt dispenser 250. In one embodiment, the kiosk 200 and order taking application 310, 410 then sends or transmits the completed order to the kitchen, such as to the order fulfillment application 340, for filling of the order in block 3322, and the kiosk 200 then displays instructions for food pick-up to the customer on the display in block 3324 as shown in FIG. 39, which can also be printed on the receipt, as described herein. The customer goes to the counter and receives the restaurant items ordered, thus completing the ordering process.

In one embodiment, instead of transmitting the completed order to the kitchen, such as to the order fulfillment application 340, for filling of the order in block 3322, after payment has been received, there are a number of alternative times or positions within the process flow that the kiosk 200 and order taking application 310, 410 can transmit the completed order to the kitchen. Specifically, the kiosk 200 and order taking application 310, 410 can transmit the completed order to the kitchen immediately after a restaurant item or meal is selected through an order taking interface screen. Alternatively, the kiosk 200 and order taking application 310, 410 can transmit the completed order to the kitchen after a predetermined or calculated amount of time has passed after a restaurant item or meal is selected through an order taking interface screen. Alternatively, the kiosk 200 and order taking application 310, 410 can transmit the completed order to the kitchen after the order taking application 310, 410 receives a communication that the order completion confirmation has been selected through an order taking interface screen and received at block 3306. Alternatively, the kiosk 200 and order taking application 310, 410 can transmit the completed order to the kitchen after the order taking application 310, 410 receives a communication that a dining location been selected through an order taking interface screen and received at block 3310. Lastly, the kiosk 200 and order taking application 310, 410 can instead transmit the completed order to the kitchen after the order taking application 310, 410 receives a communication that the order has been paid for through the kiosk 200 at block 3318.

In one embodiment of the customer kiosk 110, 120, 130, 200, the credit card reader 240 and the customer order taking application 310, 410 are configured to display an interface screen which requests the customer to insert or “swipe” their credit card, debit card or other payment card using the credit card reader 240, prior to the customer order taking application 310, 410 displaying any interface screens which otherwise allow the customer to begin requesting or selecting restaurant items. The customer will then insert or “swipe” their payment card, and the customer kiosk 110, 120, 130, 200 can be configured to validate the credit card in one of a number or ways. For example, one way of validating can include only verifying within the customer order taking application 310, 410 that the payment card is in fact a payment card without communicating with any external systems or computers, such as a credit card processing system of computer. Other ways of validating the payment card can include the customer order taking application 310, 410 communicating with an external system or computer, such as a credit card processing system or computer to validate a credit card. The interface screens having restaurant item selectors for a customer to select to include such restaurant items within their order can then be made available to the customer for such purpose. The customer then makes their selections. Once the customer has made all selections for their order and wishes to pay for the order, for example by selecting a “check out” input or icon, which is received by the customer order taking application 310, 410, the customer order taking application 310, 410 will then display an input option to use the already swiped payment card to pay for the order. The customer can then either select such input option or insert or swipe another payment card. The customer kiosk 110, 120, 130, 200 does not have to be configured to provide this option, but can alternatively just use the originally inserted or swiped payment card for payment to complete the order.

In one specific embodiment, the customer kiosk 110, 120, 130, 200 and order taking application 310, 410 are configured to receive a payment card within the credit card reader 240, and hold the payment card within the credit card reader 240 throughout the entire ordering process, until the order has been completed and payment has been validated, or until the order has been canceled by the customer. Then, and only then, is the payment card released by the order taking application 310, 410 and the credit card reader 240, and returned to the customer. During this time period, the customer kiosk 110, 120, 130, 200 and order taking application 310, 410 can perform payment card validation functions, such as, for example, by communicating with an external credit card processing system or computer.

In another embodiment of the customer kiosk 110, 120, 130, 200, the credit card reader 240 and the customer order taking application 310, 410 are configured to initially display interface screens having restaurant item selectors for a customer to select to include such restaurant items within their order, and are initially made available to the customer for such purpose without having to insert or swipe a payment card. The customer then makes their selections. Once the customer has made all selections for their order and wishes to pay for the order, for example by selecting a “check out” input or icon, which is received by the customer order taking application 310, 410, the customer order taking application 310, 410 will then display a request for the customer to insert or swipe their payment card to pay for the order. The customer order taking application 310, 410 is configured to validate the payment card, such as, for example, by validating the payment card with an external credit card processing system or computer. In other embodiments, the customer kiosk 110, 120, 130, 200 can include a contactless reader, such as an Infrared transceiver or RF (radio frequency) transceiver (not shown), for receiving payment signals from a wireless payment device, such as wireless wallet within a cell phone, PDA, or other wireless device. In addition, or alternatively, the order taking application can be configured to receive customer identification, preferences, and payment information and store such information within the local, central or other database, such as the databases 322, 330n shown in FIG. 3, for later recall and use to pay for an order and/or to suggest order items to the customer that the customer has previously ordered. U.S. Patent Application Publication 2007/0291710 to Fadell, published Dec. 20, 2007 provides some examples in this regard, and is hereby incorporated by reference herein in its entirety.

In another embodiment the customer kiosk 110, 120, 130, 200 and the customer order taking application 310, 410 can be configured to accept coupons and/or gift cards as partial payment for an order, as complete payment for an order, and/or to receive a promotional item. In the case of a coupon, through one or more of the payment interface screens, the order taking application 310, 410 can request the customer to enter coupon code by displaying such a request on the payment interface screen, and by requesting the customer to enter a coupon code through the interface screen, such as for example by entering the coupon code through a virtual keypad generated on the touch screen display 112, 122, 132, 230. Once the coupon code is received by the order taking application 310, 410, the order taking application 310, 410 validates the coupon code. If validation is successful, the order taking application 310, 410 determines the appropriate coupon action. As described, one coupon action could include reducing the total amount due for the order, in which case the order taking application 310, 410 can display the original amount due, the reduction based on the coupon, and/or the total amount due with the reduction based on the coupon applied, within one or more of the payment interface screens. Another coupon action can include adding a promotional item to the order without any additional charge, in which case the order taking application 310, 410 can display the previously ordered items along with the promotional item displayed with the previously ordered items, within one or more of the payment interface screens. Physical coupons, with or without coupon codes, can alternately be inserted into the payment card reader 240 and the order taking application 310, 410, using information from the coupon, such as from a bar code as read by a bar code reader (not shown) within the payment reader 240, can determine the amount to allow as a discount as against the ordered items and total, and/or insertion and reading of the coupon itself can initiate actual selection of a restaurant item with appropriate discount or reduction in the total. Other identifiers on coupons can be used as well, such as densu codes or encoded material deposit within a coupon. Alternatively, the kiosks 200 can include a reader that is configured to read encoded patterns (virtual coupons) displayed on the display of a cell phone or a PDA, which are received at such cell phone or PDA over the internet or other communications network, and the order taking application 310, 410m can be configured to process and implement/apply such virtual coupons. Gift cards can be utilized in a similar manner as other payment cards, such as for example a credit card, as described herein.

As described herein, when a customer has completed an order, the order taking application 310, 410 displays one or more payment interface screens for the customer to interact with for paying for the order, among other functionality. Once payment has been made using the customer kiosk 110, 120, 130, 200, or the customer has selected an option within one of the payment interface screens to pay for their order manually through an order filler (assembler/expediter) or order taker using a POS terminal 162, 164, 166, the order taking application 310, 410 and receipt dispenser 250 will generate and print a receipt at the customer kiosk 110, 120, 130, 200. In one embodiment, the order taking application 310, 410 and receipt dispenser 250 will generate and print a receipt having an order identifier, such as an order number. In one embodiment, the order numbers are generated in sequence for each order, for use in printing on the receipt. In another embodiment, the order numbers are randomly generated by the order taking application 310, 410 for each order, for use in printing on the receipt. In either case, as shown in FIG. 39, the ordering taking application 310, 410 generates and displays on an interface screen a communication and/or generates and prints on the receipt a communication, indicating to the customer to proceed to the order pickup counter to pick up their order. In one embodiment, the system can include a computer number display and/or an electromechanical number display in communication with the Point Of Sale (POS) system, such as the POS server, for displaying the order number generated by the order taking application 310, 410 once the order is ready. In one embodiment, the order is ready when an order has been filled and an order filler (assembler/expediter) has communicated to the POS system that the order is filled by the order filler (assembler/expediter) pressing a bump bar or other input device, as disclosed in U.S. Patent Application Publication No. 2007/0022016. Once the order number is displayed on the number display, as shown in FIG. 39, the customer is thereby notified to approach the order pickup counter, and can hand their receipt to the order filler (assembler/expediter) and for the order filler to present the order to the customer, among other tasks.

Within the present description, when a customer selects a restaurant item through an ordering interface screen, such as a pop-up ordering interface screen, the order taking application 310, 410 is configured to generate and display such selected restaurant item as a part of the electronic “receipt”, as shown in at least FIG. 28. In one embodiment, when the restaurant item selector for the restaurant item within the ordering interface screen is selected by the customer, the order taking application 310, 410 can be configured to generate and display a “flying” object or animation which moves from the location on the ordering interface screen where the restaurant item selector is located along a path, such as an arced path, to the location on the ordering interface screen where the receipt is located or will be located after being generated and displayed by the order taking application 310, 410. In this way, the customer is visually notified that their selection has taken place and is being performed by the customer kiosk 110, 120, 130, 200. The “flying” object or animation can take various different forms, such as an image of the selected restaurant item(s) or other form.

For each selection within each process of offering and/or selecting restaurant items, requesting and/or providing payment, and/or other customer interactions with the customer kiosk 200, incidentally with or in cooperation with the various interface screens generated and displayed by the order taking application 310, 410, the order taking application 310, 410 can also generate audio signals for creating audio requests, prompts, and confirmation communications to the customer, through for example a speaker (not shown) within the kiosk 200.

Any process descriptions or blocks in figures, such as FIGS. 3, 4, 8, 10, 13, 16, 17, 19, 21 and 33, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

What is claimed is:

1. A method for presenting restaurant items for multi-item restaurant item selection through a customer ordering kiosk having a kiosk processor and a kiosk display, the method comprising the steps of:
receiving at the kiosk processor a signal from the kiosk display representing that a multi-item restaurant item selection has been made, wherein the multi-item restaurant item selection represents selection from among a predetermined plurality of restaurant items comprising a first restaurant item and a second restaurant item;
displaying on the kiosk display a first indicator representing that the first restaurant item of the predetermined plurality of restaurant items has been selected; and,
displaying on the kiosk display a second indicator representing that the second restaurant item of the predetermined plurality of restaurant items still needs to be selected.

2. The method of claim 1 wherein the multi-item restaurant item selection is at least one of a kid's meal and a value meal.

3. The method of claim 1 wherein the predetermined plurality of restaurant items comprises a main item, a side item, and a drink item.

4. The method of claim 3 wherein the predetermined plurality of restaurant items further comprises a toy item.

5. The method of claim 3 wherein the main item comprises at least one of a burger item, a sandwich item, a salad item, a chicken item, and/or a fish item.

6. The method of claim 3 wherein the side item comprises at least one of a french fries item, a salad item, and/or a fruit item.

7. The method of claim 3 wherein the drink item comprises at least one of a soda item, a juice item, a milk item, a water item, and/or a coffee item.

8. The method of claim 1 wherein the signal received at the processor representing the multi-item restaurant selection is generated as a result of a customer selecting through the kiosk display a main item selector from a first customer interface screen on the kiosk display.

9. The method of claim 1 wherein the signal received at the processor representing the multi-item restaurant item selection also represents that a customer has selected through the kiosk display the first restaurant item of the multi-item restaurant item from a customer interface screen on the kiosk display.

10. The method of claim 1 wherein the first indicator comprises an image of the first restaurant item after the first restaurant item has been selected.

11. The method of claim 1 wherein the second indicator comprises an image of the second restaurant item after the second restaurant item has been selected.

12. The method of claim 1 wherein the second indicator comprises suggestive indicia that an additional restaurant item must be selected for the multi-item restaurant item selection.

13. The method of claim 1 further comprising the steps of:
receiving at the kiosk processor a second signal from the kiosk display representing that the second restaurant item of the predetermined plurality of restaurant items has been selected; and,
displaying on the kiosk display a modified second indicator representing that the second restaurant item of the predetermined plurality of restaurant items has been selected.

14. The method of claim 1 wherein the predetermined plurality of restaurant items further comprises a third restaurant item, and wherein the method further comprises the step of:
displaying on the kiosk display a third indicator representing that the third restaurant item of the predetermined plurality of restaurant items still needs to be selected.

15. The method of claim 14 further comprising the step of:
receiving at the kiosk processor a second signal from the kiosk display representing that the second restaurant item of the predetermined plurality of restaurant items has been selected; and,
displaying on the kiosk display a modified second indicator representing that the second restaurant item of the predetermined plurality of restaurant items has been selected.

16. The method of claim 14 wherein the predetermined plurality of restaurant items further comprises a fourth restaurant item; and wherein the method further comprises the step of:
displaying on the kiosk display a fourth indicator representing that the fourth restaurant item of the predetermined plurality of restaurant items still needs to be selected.

17. The method of claim 15 further comprising the steps of:
receiving at the kiosk processor a second signal from the kiosk display representing that the second restaurant item of the predetermined plurality of restaurant items has been selected; and,
displaying on the kiosk display a modified second indicator representing that the second restaurant item of the predetermined plurality of restaurant items has been selected.

18. The method of claim 14 further comprising the steps of:
receiving at the kiosk processor a third signal from the kiosk display representing that the third restaurant item of the predetermined plurality of restaurant items has been selected; and,
displaying on the kiosk display a modified third indicator representing that the third restaurant item of the predetermined plurality of restaurant items has been selected.

19. The method of claim 15 further comprising the steps of:
receiving at the kiosk processor a third signal from the kiosk display representing that the third restaurant item of the predetermined plurality of restaurant items has been selected; and,
displaying on the kiosk display a modified third indicator representing that the third restaurant item of the predetermined plurality of restaurant items has been selected.

20. The method of claim 19 further comprising the steps of:
receiving at the kiosk processor a fourth signal from the kiosk display representing that the fourth restaurant item of the predetermined plurality of restaurant items has been selected; and,
displaying on the kiosk display a modified fourth indicator representing that the fourth restaurant item of the predetermined plurality of restaurant items has been selected.

21. The method of claim 19 wherein the modified third indicator comprises an image of the third restaurant item after the third restaurant item has been selected.

22. The method of claim 20 wherein the fourth indicator comprises an image of the fourth restaurant item after the fourth restaurant item has been selected.

23. The method of claim 1 wherein the signal received at the processor representing the multi-item restaurant selection is generated as a result of a customer making a selection through a first customer interface screen on the kiosk display.

24. The method of claim 23 further comprising the step of:
receiving at the kiosk processor a second signal from the kiosk display representing that the second restaurant item of the predetermined plurality of restaurant items has been selected, wherein the second signal is generated as a result of a customer making a selection from a second customer interface screen on the kiosk display.

25. The method of claim 24 further comprising the step of:
receiving at the kiosk processor a third signal from the kiosk display representing that a third restaurant item of the predetermined plurality of restaurant items has been selected, wherein the third signal is generated as a result of a customer making a selection from a third customer interface screen on the kiosk display.

26. The method of claim 25 further comprising the step of:
receiving at the kiosk processor a fourth signal from the kiosk display representing that a fourth restaurant item of the predetermined plurality of restaurant items has been selected, wherein the fourth signal is generated as a result of a customer making a selection from a fourth customer interface screen on the kiosk display.

27. A method for presenting restaurant items for a multi-item order through a customer ordering kiosk having a kiosk processor and kiosk display, the method comprising the steps of:
receiving at the kiosk processor a first signal from the kiosk display representing that a first restaurant item has been selected;
after receiving the first signal, receiving at the kiosk processor a second signal from the kiosk display representing the selection of a multi-item restaurant item selection representing a predetermined plurality of restaurant items comprising the first restaurant item and a second restaurant item;
displaying on the kiosk display a first indicator representing that the first restaurant item of the predetermined plurality of restaurant items has been selected; and,
displaying on the kiosk display a second indicator representing that the second restaurant item of the predetermined plurality of restaurant items still needs to be selected.

28. A system for presenting restaurant items for ordering comprising:
a customer order taking application configured to generate customer order taking screens for ordering restaurant items;
a processor for executing the customer order taking application;
a memory for storing the customer order taking application;
a display for displaying customer order taking screens generated by the customer order taking application;
a customer input receiver for receiving selection signals;
wherein the customer order taking application is further configured to receive a signal representing that a multi-item restaurant item selection has been made, wherein the multi-item restaurant item selection represents selection of a predetermined plurality of restaurant items comprising a first restaurant item and a second restaurant item;
wherein the customer order taking application is further configured to display a first indicator representing that the first restaurant item of the predetermined plurality of restaurant items has been selected; and
wherein the customer order taking application is further configured to display a second indicator representing that the second restaurant item of the predetermined plurality of restaurant items still needs to be selected.

29. The system of claim 28 wherein the customer input receiver is a touch screen display wherein the customer can input selections by touching the touch screen display.

30. The system of claim 28 further comprising a credit card reader for receiving payments via at least one of credit cards, debit cards and gift cards.

31. The system of claim 28 further comprising a receipt dispenser for printing and dispensing a receipt to the customer upon completion of an order.

32. The system of claim 28 wherein the customer order taking application is further configured to receive a second signal representing that the second restaurant item of the predetermined plurality of restaurant items has been selected and display a modified second indicator representing that the second restaurant item of the predetermined plurality of restaurant items has been selected.

33. The system of claim 28 wherein the customer order taking application is further configured to display a third indicator representing that the third restaurant item of the predetermined plurality of restaurant items still needs to be selected.

34. The system of claim 28 wherein the processor, memory and display are housed within an independent customer kiosk.

35. The system of claim 34 further comprising a kiosk server, POS terminal server and order generation system wherein the kiosk server can communicate with the customer kiosk and the POS terminal server.

36. The system of claim 35 wherein the POS terminal server can communicate with the order generation system.

37. A computer readable medium encoded with a customer order taking application configured to receive at a kiosk processor a signal from a kiosk display representing that a multi-item restaurant item selection has been made, wherein the multi-item restaurant item selection represents selection from among a predetermined plurality of restaurant items comprising a first restaurant item and a second restaurant item;
wherein the customer order taking application is further configured to display on the kiosk display a first indicator representing that the first restaurant item of the predetermined plurality of restaurant items has been selected; and
wherein the customer order taking application is further configured to display on the kiosk display a second indicator representing that the second restaurant item of the predetermined plurality of restaurant items still needs to be selected.
